(19) United States
(12) Patent Application Publication
(10) Pub. No.: US 2023/0333705 A1
(43) Pub. Date: Oct. 19, 2023

(54) RESTRICTED INTERACTIVE GRAPHIC DESIGN ICON FOR ASSOCIATION WITH CONTENT TO BE SHARED BETWEEN USERS

(71) Applicant: Meta Platforms, Inc., Menlo Park, CA (US)

(72) Inventors: Sonja Okano Khan, Brooklyn, NY (US); Mari Sheibley, San Francisco, CA (US); Key K. Shin, Menlo Park, CA (US); Rennie Hsie Song, Stanford, CA (US)

(21) Appl. No.: 17/558,262

(22) Filed: Dec. 21, 2021

(51) Int. Cl. G06F 3/04817; H04L 51/52; H04L 67/306; G06F 3/04842; G06Q 50/00

(52) U.S. Cl. CPC G06F 3/04817; H04L 51/32; H04L 67/306; G06F 3/04842; G06Q 50/01; H04L 63/102

(57) ABSTRACT

Techniques are described for granting access to a restricted graphic design icon to use for generating modified content to be shared between users. For example, user interfaces are described that include features and/or mode controls for generating content associated with a restricted graphic design icon limited to accounts that meet a set of characteristics that can then be shared between users.

### BACKGROUND

Social networking platforms allow users to share content with one another. Users may share content such as images, video, audio, text, and other content types using social networking platforms. Oftentimes, a social networking system can provide a user with the ability to add on one or more stickers or icons (e.g., additional content, overlayed content, etc.) to a created post prior to sharing. However, the use of stickers, while entertaining often remains a static function unable to promote sharing of a topic or cause.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a schematic view of an example system usable to enable access to and sharing of restricted graphic design icons in a social networking platform as described herein.

FIGS. 2A and 2B illustrate example interfaces of mode controls for an ephemeral content creation functionality.

FIG. 3 illustrates an example process for receiving inputs to generate an item of ephemeral content using ephemeral content creation functionality.

FIG. 4 illustrates an example process for determining eligibility of association of an account with a restricted graphic design icon.

FIGS. 5A-5D illustrate example user interfaces for notification, association, and engagement of a restricted graphic design icon.

FIG. 6 illustrates an example process for generating and posting a content item with a restricted graphic design icon.

FIGS. 7A and 7B illustrate example user interfaces associated with content creation functionality associated with a restricted graphic design icon.

FIGS. 8A and 8B illustrate examples of a restricted graphic design icon including interactive features.

FIG. 9 illustrates an example system and device which may be used to implement the techniques described herein.

### DETAILED DESCRIPTION

As discussed above, social network applications allow users to capture an image and/or a video, and/or to select previously captured images and/or videos from device storage and to share content in the form of feed media which may persist or otherwise be stored in association with the user's account (unless deleted or otherwise removed) and/or to share content in the form of stories media which may be ephemeral (e.g., automatically deleted or removed unless instructed to persist).

Many conventional social media platforms that enable ephemeral media content generation and sharing may allow a user to incorporate an image or a video into an ephemeral content item. In some cases, a user may wish to share an ephemeral content item such as an inspirational quote with other users, or a relatable GIF corresponding to how the user is feeling. Additionally, in many cases, users may devote a particular post of stories media or feed media to another user or group of users. For instance, a first user may congratulate a second user or group of second users for graduating from college and share this congratulation with followers of the first user on the social network. The first user may include content in the post with images or video from a graduation ceremony, documentation of events with the first user and second user or group of second users together.

In some cases, users may customize images or video included in feed media and/or stories media within a social network application by overlaying text, adding a caption, adding stickers or icons, applying filters, or adding music, to name a few examples. A sticker or icon may include a graphic design that is configured for association with an item of content (e.g., configured to be added to an image, text, etc.). As such, the stickers may provide users with an additional means of expression by allowing them to augment their posted content. A standard set (e.g., standard collection) of stickers may be available to users of a social networking system at any time while respective accounts of the users are active. Also, in some examples, additional stickers may be available for download by any users of the social networking system, such as from third-party resources.

Although the conventional stickers or icons add expression to content, their ability to enhance user experience is limited. Conventional stickers or icons are typically passive graphic icons generally available to all users.

This application describes techniques and features to implement a social networking system configured to provide an interactive feature associated with a restricted graphic design icon, the use of which is restricted to a qualified community of accounts. In examples, an account may be an account of a social networking system, for example, a user account, a collaborative account, or any other type of account available on the social networking system. In examples, a restricted graphic design icon may include any computer graphic design. In examples, the restricted graphic design icon may include any shape or color, it may be of any size, may include text, may include a single image or multiple images. In examples, a restricted graphic design icon may include at least all the attributes of a sticker or icon. In examples, a restricted graphic design icon is a graphic such as an image, logo, writing or the like that may be added on top of another image or other content such as text or the like. In examples, the graphic may be animated or fixed. In examples, the graphic may be interactive.

In examples, a restricted graphic design icon may be associated with or include one or more interactive features. In examples, interactive features may include features enabling a user to download and/or share the restricted graphic design icon, it may include a linking feature, for example linking the posted content to a content page associated with a hashtag, or like interactive features that a user may engage.

In examples, the social networking system can leverage a restricted graphic design icon to boost interaction between an account and the social networking system, interaction among different accounts, and/or engagement with an activity, cause, movement, or association. For example, the restricted graphic design icon may encourage user interaction required to download and/or share content associated with the restricted graphic design icon.

In examples, a social networking system may identify one or more accounts that are eligible for association with one or more restricted graphic design icons, such as based on one or more characteristics associated with the account. The characteristics may include a location associated with the account (e.g., users located in a particular region or area, etc.), accounts that are active at a particular time, accounts that are associated with a particular activity and/or connected to particular other accounts, user information (e.g., demographics, group or organization affiliations, employment data, etc.) and/or characteristics associated with the user and/or the account. In at least one example, the social networking system may render a restricted graphic design icon available for association with an account based on a determination that the account satisfies a criteria or is associated with a characteristic associated with the restricted graphic design icon.

In examples, users associated with accounts that qualify to share the restricted graphic design icon may be presented with an interactive feature associated with the restricted graphic design icon. In examples, the interactive feature may enable a download of the restricted graphic design icon, including its meta data, in association with an account, such as to a collection of stickers or icons (e.g., sticker tray, icon tray, etc.). In examples, the interactive feature may be associated with one or more content creation functionalities such as an image capture and/or a text box. In examples, the restricted graphic design icon may be displayed simultaneously with a content creation interface associated with the content creation functionality. In examples, the restricted graphic design icon may be displayed with a content creation functionality before, during, and/or after content is created. For example, the restricted graphic design icon may appear on a camera screen in preview mode, in a text box where text is being typed, or a combination thereof.

In examples, the restricted graphic design icon may have a limited or unlimited availability status. In examples in which the restricted graphic design icon has a limited availability status, the restricted graphic design icon may be configured to remain available during a period of time. The period of time may include a fixed time interval (e.g., one week, one month, etc.) or it may be associated with determined dates (e.g., from May 1^{st} to May 31^{st}, etc.). In response to determining that the period of time associated with a restricted graphic design icon has expired, the social networking system may render the restricted graphic design icon unavailable for use by a user. For example, in response to determining that a period of time associated with a restricted graphic design icon has passed, the social networking system may cause the restricted graphic design icon to be deleted from an account and/or may remove the restricted graphic design icon from presentation in association with the collection of stickers or icons associated with the account. For another example, the social networking system may disable the interactive feature associated with the restricted graphic design icon, thereby limiting interaction with the restricted graphic design icon to viewing. In such an example, the social networking system may disable functionalities associated with sharing, downloading, and/or otherwise associating the restricted graphic design icon with the account.

In examples, content posted with a restricted graphic design icon that is no longer associated with an interactive feature for accessing the restricted graphic design icon may still show the restricted graphic design icon. In examples, a restricted graphic design icon that is no longer available may include a restricted graphic design icon that either exhibits limited functionality and/or is associated only with an interactive feature having limited functionality. For example, the restricted graphic design icon may retain its functionality as a hyperlink associated with a hashtag, as described below.

In examples, a restricted graphic design icon may be associated with one or more hashtags. In examples, a restricted graphic design icon may be an interactive element itself or be associated with an interactive feature that, when selected, may function as a hyperlink to a content page associated with one or more hashtags. In examples, an interface with an interactive restricted graphic design icon may be enabled as an interactive graphic interface, or as an interactive link that may be selected via a gesture using a touchscreen or by other input device such as a keyboard, pointer, stylus, or similar input device. In examples, selection of the interactive graphic interface may correspond to an input to the social networking system and/or social network application.

In examples, the social networking system that provides a restricted graphic design icon may improve user experience by encouraging a sense of pride in community among users who are associated with the restricted graphic design icon. Also, the system as described may improve user experience by providing an incentive for users to participate in an activity to gain access to the restricted graphic design icon. For example, a user may be encouraged to visit a given prefecture during the torch carrying relay of the Olympic Games to retain access to a restricted graphic design icon.

In examples, the social networking system may leverage restricted graphic design icons to promote interaction among users, increase post visibility and shares, increase user engagement, or any combination thereof. For example, a first user may be encouraged to interact with the post of a second user to access a restricted graphic design icon.

Various embodiments of the present disclosure include systems, methods, and non-transitory computer-readable media of a social networking system.

In examples, a method including identifying a characteristic associated with a first account of a social networking system; determining, based at least in part on the characteristic, that the first account is eligible for association with a restricted graphic design icon provided by the social networking system, the restricted graphic design icon configured for association with content to be posted via the social networking system; based at least in part on a determination that the first account is eligible for association with the restricted graphic design icon, causing presentation, on a user interface associated with the first account, of a selectable control associated with the restricted graphic design icon, the selectable control enabling an association between the first account and the restricted graphic design icon; in response to receiving an indication of selection of the selectable control, causing presentation, via the user interface, of the restricted graphic design icon in association with content to be posted via the social networking system, wherein the restricted graphic design icon modifies the content to be posted; receiving, via the user interface, a request to post modified content comprising the content and the restricted graphic design icon; and causing presentation, in association with the first account and a second account that is connected to the first account via the social networking system, of the modified content.

In examples, identifying the characteristic associated with a first account may include receiving information associated with the first account, the information comprising at least one of: user information associated with the first account; account setting associated with the first account; interaction data associated with the first account; or a location of a computing device associated with the first account.

In examples, determining that the first account is eligible for association with the restricted graphic design icon may include determining that a location of a user computing device associated with the first account is within a threshold distance of a designated location.

In examples, presenting of the selectable control associated with the restricted graphic design icon comprises displaying an interactive feature on a home screen, as part of a newsfeed, as an attribution link on a content post by an account other than the first account, or any combination thereof.

In examples, causing presentation of the restricted graphic design icon in association with the content may include causing presentation of a content creation interface including at least one of an image capture mode control, or a text box. In examples, the content creation interface may include the image capture mode control, the content may include an image, and the restricted graphic design icon is presented in association with the image in a preview mode of the content creation interface. In examples, the restricted graphic design icon may be presented in association with a first portion of the image, the method further including receiving an input to associate the restricted graphic design icon with a second portion of the image; and in response to the input, associating the restricted graphic design icon with the second portion of the image in the preview mode.

In examples, the method may include associating with the modified content at least one of an attribution link associated with the restricted graphic design icon; or a hashtag link associated with the restricted graphic design icon.

In examples, receiving the request to post the modified content may include receiving a request to post the modified content in association with a newsfeed, a user profile associated with the first account, a home screen, a story comprising ephemeral content.

In examples, a system may include one or more processors; and one or more computer-readable media storing instructions that, when executed by the one or more processors, cause the one or more processors to perform operation that may include identify a characteristic associated with a first account of a social networking system; determine, based at least in part on the characteristic, that the first account is eligible for association with a restricted graphic design icon provided by the social networking system, the restricted graphic design icon configured for association with content to be posted via the social networking system; based at least in part on a determination that the first account is eligible for association with the restricted graphic design icon, cause presentation, on a user interface associated with the first account, of a selectable control associated with the restricted graphic design icon, the selectable control configured to enable an association between the first account and the restricted graphic design icon; in response to receipt of an indication of selection of the selectable control, cause presentation, via the user interface, of the restricted graphic design icon in association with content to be posted via the social networking system, wherein the restricted graphic design icon modifies the content to be posted; receive, via the user interface, a request to post modified content comprising the content and the restricted graphic design icon; and cause a presentation, in association with the first account and a second account that is connected to the first account via the social networking system, of the modified content.

In examples, the one or more computer-readable media storing instructions may cause the one or more processors to identify a characteristic associated with a first account based on one or more of: information of a user associated with the first account, account settings associated with the first account, interaction data associated with the first account, location of a computing device associated with the first account, or any combination thereof.

In examples, the one or more computer-readable media storing instructions may cause the one or more processors to display the selectable control on a home screen, displaying the selectable control as part of a newsfeed, displaying the selectable control as an attribution link on a content post from an account other than the first account, or any combination thereof.

In examples, the one or more computer-readable media storing instructions may cause the one or more processors to simultaneously display a content creation functionality and the restricted graphic design icon before the content is created.

In examples, the one or more computer-readable media storing instructions may cause the one or more processors to associate with the modified content at least one of: an attribution link associated with the restricted graphic design icon; or a hashtag link associated with the restricted graphic design icon.

In examples, one or more non-transitory computer-readable media storing instructions that, when executed by one or more processors, cause the one or more processors to perform operations that may include identify a characteristic associated with a first account of a social networking system; determine, based at least in part on the characteristic, that the first account is eligible for association with a restricted graphic design icon provided by the social networking system, the restricted graphic design icon configured for association with content to be posted via the social networking system; based at least in part on a determination that the first account is eligible for association with the restricted graphic design icon, cause presentation, on a user interface associated with the first account, of a selectable control associated with the restricted graphic design icon, the selectable control configured to enable an association between the first account and the restricted graphic design icon; in response to receipt of an indication of selection of the selectable control, cause presentation, via the user interface, of the restricted graphic design icon in association with content to be posted via the social networking system, wherein the restricted graphic design icon modifies the content to be posted; receive, via the user interface, a request to post modified content comprising the content and the restricted graphic design icon; and cause a presentation, in association with the first account and a second account that is connected to the first account via the social networking system, of the modified content.

In examples, the storing instructions may cause the one or more processors to identify a characteristic associated with a first account based on one or more of: information of a user associated with the first account, account settings associated with the first account, interaction data associated with the first account, location of a computing device associated with the first account, or any combination thereof.

In examples, the storing may cause the one or more processors to display the selectable control comprises display of an interactive feature on a home screen, as part of a newsfeed, an attribution link on a content post by an account other than the first account, or any combination thereof.

In examples, the storing may cause the one or more processors to simultaneously display a content creation functionality and the restricted graphic design icon before the content is created.

In examples, the storing may cause the one or more processors to associate with the modified content at least one of: an attribution link associated with the restricted graphic design icon; or a hashtag link associated with the restricted graphic design icon.

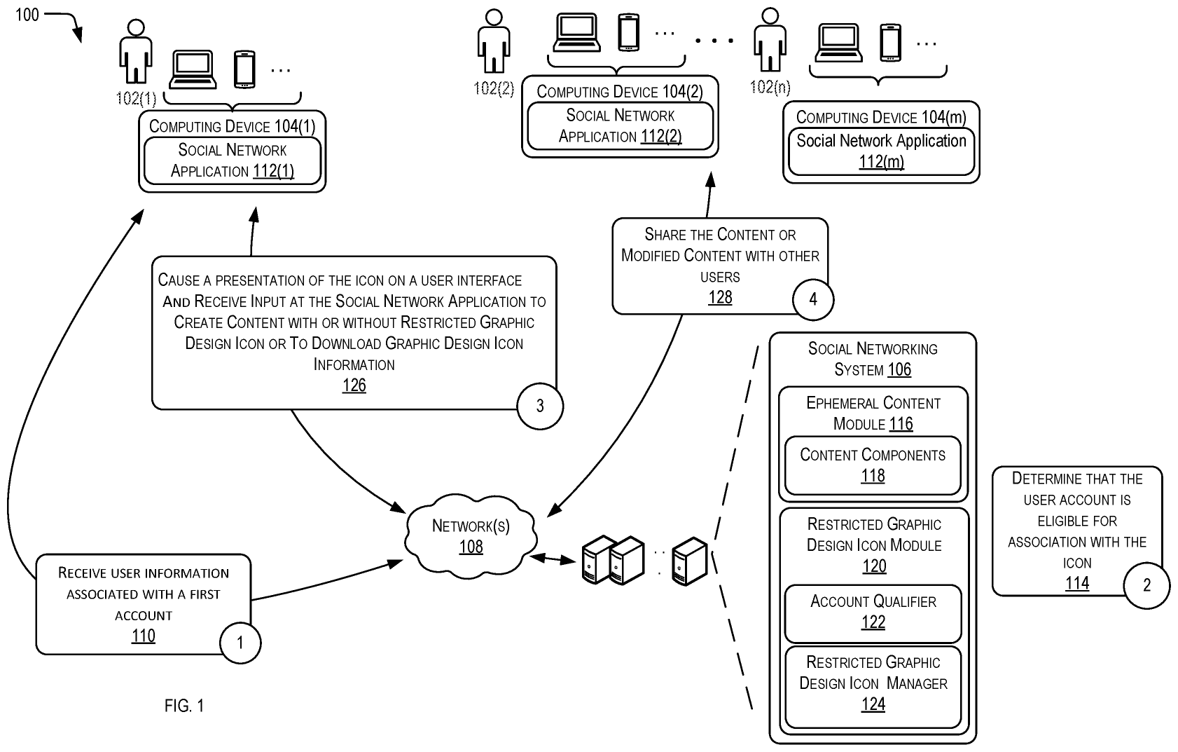

FIG. 1 is a schematic view of an example computing system 100 usable to implement example techniques described herein to generate content to be shared between users via the system 100. In some examples, the system 100 may include users 102(1), 102(2), . . . 102(n) (collectively “users 102”) to interact using computing devices 104(1), 104(2), . . . 104(m) (collectively “computing devices 104”) with a social networking system 106 via a network 108. In this example, n and m are non-zero integers greater than 1.

Each of the computing devices 104 includes one or more processors and memory storing computer executable instructions to implement the functionality discussed herein attributable to the various computing devices. In some examples, the computing devices 104 may include desktop computers, laptop computers, tablet computers, mobile devices (e.g., smart phones or other cellular or mobile phones, mobile gaming devices, portable media devices, etc.), or other suitable computing devices. The computing devices 104 may execute one or more client applications, such as a web browser (e.g., Microsoft Windows Internet Explorer, Mozilla Firefox, Apple Safari, Google Chrome, Opera, etc.) or a native or special-purpose client application (e.g., social media applications, messaging applications, email applications, games, etc.), to access and view content over the network 108.

The network 108 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the computing devices 104 may access the social networking system 106 and/or communicate with one another.

The social networking system 106 may include one or more servers or other computing devices, any or all of which may include one or more processors and memory storing computer executable instructions to implement the functionality discussed herein attributable to the social networking system 106 or digital platform. The social networking system 106 may enable its users 102 (such as persons or organizations) to interact with the social networking system 106 and with each other via the computing devices 104. The social networking system 106 may, with input from a user, create and store in the social networking system 106 an account associated with the user. The account may include demographic information, communication-channel information, and information on personal interests of the user. The social networking system 106 may also, with input from a user, create and store a record of relationships of the user with other users of the social networking system 106, as well as provide services (e.g., posts, comments, photo-sharing, messaging, tagging, mentioning of other users or entities, games, etc.) to facilitate social interaction between or among the users 102.

The social networking system 106 may be configured to provide content creation techniques to the users 102. For instance, the social networking system 106 may be configured to generate content (e.g., ephemeral content) to be shared between users based on selections made by a user 102(1).

In some examples, the social network application may comprise ephemeral content creation functionality, as described herein. As discussed above, “ephemeral content” refers to content comprising objects (e.g., posts, photos, text, videos, GIFs, icons, stickers, and the like) or information that is shared with at least one other user for a finite period of time (e.g., one hour, one day, one week, etc.).

In examples, the content creation functionality may include a mode control in which a user supplies an image or a video to be included in the item of ephemeral content. For example, the user may supply an image or a video from a camera accessed by the social media application on the computing device, from storage of the computing device, from cloud storage, and so forth. In some examples, the user may add features to the image or video to be included in the item of ephemeral content, such as a countdown icon that dynamically updates an amount of time to an event chosen by the user, a quiz icon that enables other users to answer a quiz created by the user, or the like.

In examples, the content creation functionality may include a mode control in which the user is not required (although may still be able to, if desired) to supply an image or a video to be included in the item of ephemeral content. In examples, this latter mode control may enable the user to select from content supplied by a social networking system to the social network application, as well as enable the user to customize the content supplied by the social networking system. In examples, this mode control may include various features that enable the user to create customized content, such as to generate a post including text, an image, a video, and/or the like, and associate a restricted graphic design icon therewith. The user may then share the customized content with one or more other accounts of the social networking system 106.

As used herein, “shared content” or “sharing content” refers to content being associated with two (or more) accounts. Some examples of shared content include content that a first account has tagged as being associated with a second account, content that the second account has tagged as being associated with the first account, content of a post of the second account on which the first account has commented (and vice versa), content of a post of the second account which the first account has “liked” (and vice versa), messages from the first account to the second account (and vice versa), and the like. Additionally, in some cases, for example if authorized or opted in by the first and/or second users, the social networking system may identify shared content using computer vision techniques (e.g., facial recognition), such as in a case where the first user captured an image or video of a user associated with the second account, but did not manually tag the second account in the content.

In examples, the social networking system may be configured to identify one or more characteristics associated with an account of a social networking system and, based on the characteristic(s), determine whether the account may be granted access to use and/or download a restricted graphic design icon. The characteristic may include information regarding the user, information about account settings, information about interaction data associated with the account, geolocation of the computing device 104 used to access social network application 112, or any combination thereof. In examples, the social networking system 106 may determine that an account is eligible for association with the graphic design icon based on a determination that the characteristic satisfies criteria associated with the restricted graphic design icon.

For example, at operation 110, (indicated by “1”), the social networking system 106 may determine whether an active account qualifies for a particular restricted graphic design icon campaign governed by the restricted graphic design icon module 120. In examples, the social networking system 106 may gather account information to receive first account characteristics that may then be reviewed by account qualifier 122. In examples, the first account may be associated with a first user. In examples, the account information for a first account, such as first account of a user 102(1), may include any one or more of a geographic location of a computing device 104(1) through which a user is accessing the social network application 112(1), a time period such as a date and/or time of when the user 102(1) may be active on the social network application 112(1), a user 102(1) demographic information, a link between the first account of user 102(1) and any one or more other accounts of a particular set of accounts tracked by the restricted graphic design icon module 120, a cause, event, activity, or special group associated with the first account of user 102(1), or any combination thereof.

In examples, the receipt of account information at operation 110 and the identification of the first account characteristics may be conducted either automatically for one or more active accounts and/or triggered upon receipt of a first input signal via a social network application 112(1) installed on the computing device 104(1). In examples, the first input may correspond to an input to access or open the social network application 112(1), and/or an input to access a content creation functionality of the social network application 112(1), to name a few examples.

Based on the first account information, at operation 114 (indicated by “2”) the account qualifier 122 may determine whether the first account for user 102(1) includes the characteristics to qualify the first account to be associated with one or more restricted graphic design icons.

In examples, when the account qualifier 122 determines that the first account associated with user 102(1) does not qualify for association with a restricted graphic design icon, the social networking system 106 may interact with the social network application 112(1) of user 102(1) in the typical manner, without identification of any triggers to associate a restricted graphic design icon.

In examples, when the account qualifier 122 determines that the first account associated with user 102(1) qualifies to be associated with a restricted graphic design icon, a signal may cause restricted graphic design icon manager 124 to trigger presentation of the restricted design icon to user 102(1) via social network application 112(1) at computing device 104. In examples, presentation of the restricted design icon may be a notification provided as an interactive feature to access the restricted graphic design icon. In examples, the interactive feature may be presented in the newsfeed or homepage displayed to the user via the social network application 112(1) and computing device 104(1). In examples, the interactive feature may be presented as an attribution link included on an item of ephemeral content created by a different user. As used herein, an “attribution link” is a link or interface feature provided together with a posted content that allows for download and/or engagement of the restricted graphic design icon.

At operation 126 (indicated by “3”), the social networking system 106 may receive a second input via a social network application 112(1) installed on the computing device 104(1) to create an item of ephemeral content. In examples, the second input may be unassociated with the interactive feature that provides access to the restricted graphic design icon. For example, the second input may be a standard request to create content not associated with the restricted graphic design icon. In examples, the second input may include a request to save or download metadata and/or other restricted graphic design icon information onto the user tray. In examples, the second input may include a request to create content to be associated with the restricted graphic design icon.

In examples, the request to create content may include a selection of a content creation functionality of the social network application 112(1), where the content creation mode control enables the user 102(1) to create an item of ephemeral content that includes an image or a video. For instance, the social networking application 112(1) may access the image or the video to be included in the item of ephemeral content created using the normal mode control from a camera of the computing device 104(1), storage of the computing device 104(1), cloud storage (not explicitly pictured), and so forth.

Alternatively or additionally, the second input may include selection of a content creation functionality of the social network application 112(1), where the content creation mode control enables the user 102(1) to create an item of ephemeral content independent of an image or a video supplied by the user 102(1). For instance, the social networking system 106 may supply content to be included in the item of ephemeral content, as described herein.

In examples, the second input may include a request to customize an existing item of ephemeral content. Customization may take a variety of forms. For example, in a text feature of the create mode control, the second input may include the user 102(1) inputting custom text using a keyboard, speech, selection of suggested words/phrases, or other input method, changing a background upon which the customized text will be displayed when the item of ephemeral content is shared, adding icons or other graphics, adding a drawing input, and the like. Additional customizations are described in U.S. Pat. Nos. 11,042,261 and 11,048,384, both of which are incorporated herein by reference in their entirety.

In examples, the social networking system 106 may supply to the social network application 112(1) one or more content components 118 to the social network application 112(1) via ephemeral content module 116. For instance, the ephemeral content module 116 may receive the indication of the second input, such as a content creation functionality and/or a feature being used by the user 102(1).

Based on the indication of a content creation functionality and/or feature being used by the user 102(1), the ephemeral content module 116 may supply corresponding content from the content components 118 to the social network application 112(1) corresponding to the content creation functionality and/or feature. In examples, the ephemeral content module 116 may receive an indication that the user 102(1) has selected a “templates” feature of the content creation functionality, and may supply a template from the content components 118 to the social network application 112(1), which may then be customized by the user 102(1) using the social network application 112(1).

The content components 118 may include, but are not limited to: backgrounds, text (e.g., font, color, size, etc.), GIFs, templates to insert content (e.g., text, images, video, non-shareable and non-restricted graphic design icons, icons, and the like), events associated with an account of the user 102(1) (e.g., when the account followed and/or was followed by another account), predetermined polls (e.g., including a topic and/or answers to the poll), predetermined questions, countdown icons, predetermined countdowns (e.g., to a predetermined event, such as the weekend or a holiday), quiz icons, predetermined quizzes (e.g., having a predetermined topic and/or predetermined answers to the quiz), content shared between the account of the user 102(1) and one or more other users 102(2)-102(n) (e.g., posts and/or stories media that includes both accounts), and so on.

In examples, the second input signal may be received by the selection of the interactive element that provides the option to unlock the restricted graphic design icon. In examples, the second input signal may include only a request for downloading the restricted graphic design icon onto the sticker tray. In examples, the second input signal may include a request for creating content to be associated with the restricted graphic design icon.

In examples, the second input signal requesting download of the information onto the sticker tray and/or requesting to create content to be associated with the restricted graphic design icon may trigger the download of the information onto the sticker tray. In examples, the social networking system 106 may cause the restricted graphic design icon information, including associated metadata, to be downloaded to the user 102(1) sticker tray. Once stored into the sticker tray of an account, the restricted graphic design icon may be used by the user of that account on future posts.

In examples, when the second input signal only requests download of the restricted graphic design icon onto the sticker tray, the process returns to the standard operation while or after the information associated with the restricted graphic design icon is downloaded. In examples, once in the sticker tray, the restricted graphic design icon may appear to the user as any other sticker in the sticker tray.

In examples, the request to create content may be made in conjunction with the request to unlock the restricted graphic design icon and that the content to be created is to be associated with a restricted graphic design icon. In examples, upon selection of the interactive element to engage the restricted graphic design icon, the previously content creation functionalities may be provided in combination with the restricted graphic design icon. For example, the restricted graphic design icon may appear as part of the content being created.

In examples, the restricted graphic design icon may be provided as a content component 118 by ephemeral content module 116. In examples, the restricted graphic design icon may be provided by ephemeral content module 116 separately from other content components 118. In examples, the restricted graphic design icon may be provided by the restricted graphic design icon manager 124 in conjunction via ephemeral content module 116 and/or in a similar manner as ephemeral content module 116 provides content components 118.

In examples, the restricted graphic design icon may appear on the display of the computing device 104(1) before content is created, while the content is being created, and/or after the content has been created. In examples, where the content creation functionality may include an image or video capturing mode, the restricted graphic design icon may appear during preview mode, during image or video capture, and/or post capture. In examples, where the content creation functionality is a text box, the restricted graphic design icon may appear in the textbox before, during, and/or after the text is entered.

In examples, the restricted graphic design icon may appear in the same manner as a sticker. In examples, the restricted graphic design icon may be repositionable, resizable, or both. In examples, the restricted graphic design icon may be interactive and allow for repositioning before, during, or after content creation. For example, in image or video capturing mode, the restricted graphic design icon may be configured to allow for displacement across a display during preview mode, during image or video capture, and/or after capture of the image or video. In example, similar interactive repositioning of the restricted graphic design icon may be provided for a text box or any other content creation functionality.

In examples, the restricted graphic design icon modifies a content created via content creation functionalities as described by combining with the created content. For example, if the content creation functionality selected is an image capturing mode, then the restricted graphic design icon may modify the content created, i.e. a captured image or video, by becoming part of the content, i.e. appear over the image or video in a similar manner as a sticker would. Similarly, if the content creation functionality selected included a text box, the restricted graphic design icon may modify the content created by appearing in the text box in a similar manner as a sticker would. Thus, in examples, when indicated by the second input, the restricted design graphic icon may become part of the ephemeral content being created.

At operation 128 (indicated by “4”), the social network application 112(1) may share the item of ephemeral content, as customized, with the social network applications 112(2)-(m) installed on the computing devices 104(2)-104(m), e.g., via the social networking system 106. In examples, where the ephemeral content is modified by the restricted design graphic icon as described earlier, the social network application 112(1) may share the modified content.

In examples, the user 102(1) may select an option in a user interface displayed by the social network application 112(1) to share the item of ephemeral content and/or modified content either in an unrestricted manner and/or only with followers of the user 102(1). The social network application 112(1) may send the completed item of ephemeral content or modified content, including the content supplied by the social networking system 106, the restricted design graphic icon if included, and customizations by the user 102(1) according to the operation 126, to the social networking system 106. At operation 128, the social networking system 106 may then distribute the item of ephemeral content or modified content in accordance with the directive of user 102(1).

When the computing devices 104(2)-104(m) display the item of ephemeral content or modified content to the users 102(2)-102(n), the social network application 112(2)-(m) may allow the users 102(2)-102(n) to interact with the item of ephemeral content or modified content.

In examples, when the modified content of a first user 102(1) is presented to a second user, such as for example, user 102(2), the social networking system 106 may determine if the account associated with user 102(2) may include characteristics to be associated with the restricted graphic design icon and repeat the process for account 102(2) in the same manner described above for account 102(1). In examples, if account of user 102(2) qualifies to be associated with the restricted graphic design icon, then the modified content of user 102(1) when displayed to user 102(2) may contain an attribution link in addition to the restricted graphic design icon. In examples, the attribution link may be an interactive feature that allows user 102(2) to access the restricted graphic design icon. In examples, if the account of user 102(2) qualifies to access the restricted graphic design icon, one or more additional interactive features associated with the restricted graphic design icon may also be provided to account of user 102(2) in the same manner described earlier with respect to user 102(1).

In examples, the social networking system 106 may provide privacy features to the users 102 while interacting with the social networking system 106. In examples, one or more objects (e.g., content or other types of objects) of the computing system 100 may be associated with one or more privacy settings. The one or more objects may be stored on or otherwise associated with any suitable computing system or application, such as, for example, the social networking system 106, a client system, a third-party system, a social networking application, a messaging application, a photo-sharing application, or any other suitable computing system or application. Although the examples discussed herein are in the context of an online social network, these privacy settings may be applied to any other suitable computing system. Privacy settings (or “access settings”) for an object or item of content may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” and/or a “restricted list” of users or other entities that should not be allowed to access certain information associated with the object. In particular examples, the blocked list may include third-party entities. The blocked list or restricted list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular examples, privacy settings may be based on one or more nodes or edges of a social graph. A privacy setting may be specified for one or more edges or edge-types of the social graph, or with respect to one or more nodes or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a user 102(1) may share an object to the social networking system 106. The object may be associated with a concept node connected to a user node of the user 102(1) by an edge. The user 102(1) may specify privacy settings that apply to a particular edge connecting to the concept node of the object, or may specify privacy settings that apply to all edges connecting to the concept node. In some examples, the user 102(1) may share a set of objects of a particular object-type (e.g., a set of images). The user 102(1) may specify privacy settings with respect to all objects associated with the user 102(1) of that particular object-type as having a particular privacy setting (e.g., specifying that all images posted by the user 102(1) are visible only to friends of the user and/or users tagged in the images).

In particular examples, the social networking system 106 may present a “privacy wizard” (e.g., within a webpage, a module, one or more dialog boxes, or any other suitable interface) to the user 102(1) to assist the user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the social networking system 106 may offer a “dashboard” functionality to the user 102(1) that may display, to the user 102(1), current privacy settings of the user 102(1). The dashboard functionality may be displayed to the user 102(1) at any appropriate time (e.g., following an input from the user 102(1) summoning the dashboard functionality, following the occurrence of a particular event or trigger action). The dashboard functionality may allow the user 102(1) to modify one or more of the user's current privacy settings at any time, in any suitable manner (e.g., redirecting the user 102(1) to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, one or more servers of the social networking system 106 may be authorization/privacy servers for enforcing privacy settings. In response to a request from the user 102(1) (or other entity) for a particular object stored in a data store, the social networking system 106 may send a request to the data store for the object. The request may identify the user 102(1) associated with the request and the object may be sent only to the user 102(1) (or a client system of the user) if the authorization server determines that the user 102(1) is authorized to access the object based on the privacy settings associated with the object. If the requesting user is not authorized to access the object, the authorization server may prevent the requested object from being retrieved from the data store or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular examples, an object may represent content that is visible to a user through a newsfeed of the user. As an example and not by way of limitation, one or more objects may be visible to a user's “Trending” page. In particular examples, an object may correspond to a particular user. The object may be content associated with the particular user, or may be the particular user's account or information stored on the social networking system 106, or other computing system. As an example and not by way of limitation, the user 102(1) may view one or more other users 102(2) . . . 102(n) of an online social network through a “People You May Know” function of the online social network, or by viewing a list of friends of the user 102(1). As an example and not by way of limitation, the user 102(1) may specify that they do not wish to see objects associated with a particular other user (e.g., the user 102(2)) in their newsfeed or friends list. If the privacy settings for the object do not allow it to be surfaced to, discovered by, or visible to the user 102(1), the object may be excluded from the search results. Although this disclosure describes enforcing privacy settings in a particular manner, this disclosure contemplates enforcing privacy settings in any suitable manner.

In particular examples, different objects of the same type associated with a user may have different privacy settings. Different types of objects associated with a user may also have different types of privacy settings. As an example and not by way of limitation, the user 102(1) may specify that the user's status updates are public, but any images shared by the user are visible only to the user's friends on the online social network. In some examples, the user 102(1) may specify different privacy settings for different types of entities, such as individual users, friends-of-friends, followers, user groups, or corporate entities. In some examples, the user 102(1) may specify a group of users that may view videos posted by the user 102(1), while keeping the videos from being visible to the user's employer. In particular examples, different privacy settings may be provided for different user groups or user demographics. As an example and not by way of limitation, the user 102(1) may specify that other users who attend the same university as the user 102(1) may view the user's pictures, but that other users who are family members of the user 102(1) may not view those same pictures.

In particular examples, the social networking system 106 may provide one or more default privacy settings for each object of a particular object-type. A privacy setting for an object that is set to a default may be changed by a user associated with that object. As an example and not by way of limitation, all images posted by the user 102(1) may have a default privacy setting of being visible only to friends of the first user and, for a particular image, the user 102(1) may change the privacy setting for the image to be visible to friends and friends-of-friends.

In particular examples, privacy settings may allow the user 102(1) to specify (e.g., by opting out, by not opting in) whether the social networking system 106 may receive, collect, log, or store particular objects or information associated with the user 102(1) for any purpose. In particular examples, privacy settings may allow the user 102(1) to specify whether particular applications or processes may access, store, or use particular objects or information associated with the user. The privacy settings may allow the user 102(1) to opt in or opt out of having objects or information accessed, stored, or used by specific applications or processes. The social networking system 106 may access such information in order to provide a particular function or service to the user 102(1), without the social networking system 106 having access to that information for any other purposes. Before accessing, storing, or using such objects or information, the social networking system 106 may prompt the user 102(1) to provide privacy settings specifying which applications or processes, if any, may access, store, or use the object or information prior to allowing any such action. As an example and not by way of limitation, the user 102(1) may transmit a message to the user 102(2) via an application related to the online social network (e.g., a messaging app), and may specify privacy settings that such messages should not be stored by the social networking system 106.

In particular examples, the user 102(1) may specify whether particular types of objects or information associated with the user 102(1) may be accessed, stored, or used by the social networking system 106. As an example and not by way of limitation, the user 102(1) may specify that images sent by the user 102(1) through the social networking system 106 may not be stored by the social networking system 106. In some examples, the user 102(1) may specify that messages sent from the user 102(1) to another user 102(2) may not be stored by the social networking system 106. In some cases, the user 102(1) may specify that all objects sent via a particular application may be saved by the social networking system 106.

In particular examples, privacy settings may allow the user 102(1) to specify whether particular objects or information associated with the user 102(1) may be accessed from particular client systems or third-party systems. The privacy settings may allow the user 102(1) to opt in or opt out of having objects or information accessed from a particular device (e.g., the phone book on a user's smart phone), from a particular application (e.g., a messaging app), or from a particular system (e.g., an email server). The social networking system 106 may provide default privacy settings with respect to each device, system, or application, and/or the user 102(1) may be prompted to specify a particular privacy setting for each context. As an example and not by way of limitation, the user 102(1) may utilize a location-services feature of the social networking system 106 to provide recommendations for restaurants or other places in proximity to the user 102(1). The default privacy settings of the user 102(1) may specify that the social networking system 106 may use location information provided from the computing device 104(1) of the user 102(1) to provide the location-based services, but that the social networking system 106 may not store the location information of the user 102(1) or provide it to any third-party system. The user 102(1) may then update the privacy settings to allow location information to be used by a third-party image-sharing application in order to geo-tag photos.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example and not by way of limitation, a user may specify that a particular image uploaded by the user is visible to the user's friends for the next week, after which time the image may no longer be accessible to other users. In some examples, a company may post content related to a product release ahead of the official launch, and specify that the content may not be visible to other users until after the product launch.

In particular examples, for particular objects or information having privacy settings specifying that they are ephemeral, the social networking system 106 may be restricted in its access, storage, or use of the objects or information. The social networking system 106 may temporarily access, store, or use these particular objects or information in order to facilitate particular actions of a user associated with the objects or information, and may subsequently delete the objects or information, as specified by the respective privacy settings. As an example and not by way of limitation, the user 102(1) may transmit a message to the user 102(2), and the social networking system 106 may temporarily store the message in a data store until the user 102(2) has viewed or downloaded the message, at which point the social networking system 106 may delete the message from the data store. In some examples, continuing with the prior example, the message may be stored for a specified period of time (e.g., 2 weeks), after which point the social networking system 106 may delete the message from the data store.

In particular examples, changes to privacy settings may take effect retroactively, affecting the visibility of objects and content shared prior to the change. As an example and not by way of limitation, the user 102(1) may share a first image and specify that the first image is to be public to all other users. At a later time, the user 102(1) may specify that any images shared by the user 102(1) should be made visible only to a first user group. The social networking system 106 may determine that this privacy setting also applies to the first image and make the first image visible only to the first user group. In particular examples, the change in privacy settings may take effect only going forward. Continuing the example above, if the user 102(1) changes privacy settings and then shares a second image, the second image may be visible only to the first user group, but the first image may remain visible to all users. In particular examples, in response to a user action to change a privacy setting, the social networking system 106 may further prompt the user to indicate whether the user wants to apply the changes to the privacy setting retroactively. In particular examples, a user change to privacy settings may be a one-off change specific to one object. In particular examples, a user change to privacy may be a global change for all objects associated with the user.

In particular examples, the social networking system 106 may determine that user 102(1) may want to change one or more privacy settings in response to a trigger action associated with the user 102(1). The trigger action may be any suitable action on the online social network. As an example and not by way of limitation, a trigger action may be a change in the relationship between a first and second user of the online social network (e.g., “un-friending” a user, changing the relationship status between the users, etc.). In particular examples, upon determining that a trigger action has occurred, the social networking system 106 may prompt the user 102(1) to change the privacy settings regarding the visibility of objects associated with the user 102(1). The prompt may redirect the user 102(1) to a workflow process for editing privacy settings with respect to one or more entities associated with the trigger action. The privacy settings associated with the user 102(1) may be changed only in response to an explicit input from the user 102(1), and may not be changed without the approval of the user 102(1). As an example and not by way of limitation, the workflow process may include providing the user 102(1) with the current privacy settings with respect to the user 102(2) or to a group of users (e.g., un-tagging the user 102(1) or the user 102(2) from particular objects, changing the visibility of particular objects with respect to the user 102(2) or a group of users), and receiving an indication from the user 102(1) to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (i.e., “public”). However, if the user changes his or her relationship status, the social networking system 106 may determine that such action may be sensitive and may prompt the user to confirm that his or her relationship status should remain public before proceeding. In some examples, a user's privacy settings may specify that the user's posts are visible only to friends of the user. However, if the user changes the privacy setting for his or her posts to being public, the social networking system 106 may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example and not by way of limitation, the social networking system 106 may send a reminder to the user to confirm his or her privacy settings every six months or after every ten photo posts. In particular examples, privacy settings may also allow users to control access to the objects or information on a per-request basis. As an example and not by way of limitation, the social networking system 106 may notify the user whenever a third-party system attempts to access information associated with the user, and require the user to provide verification that access should be allowed before proceeding.

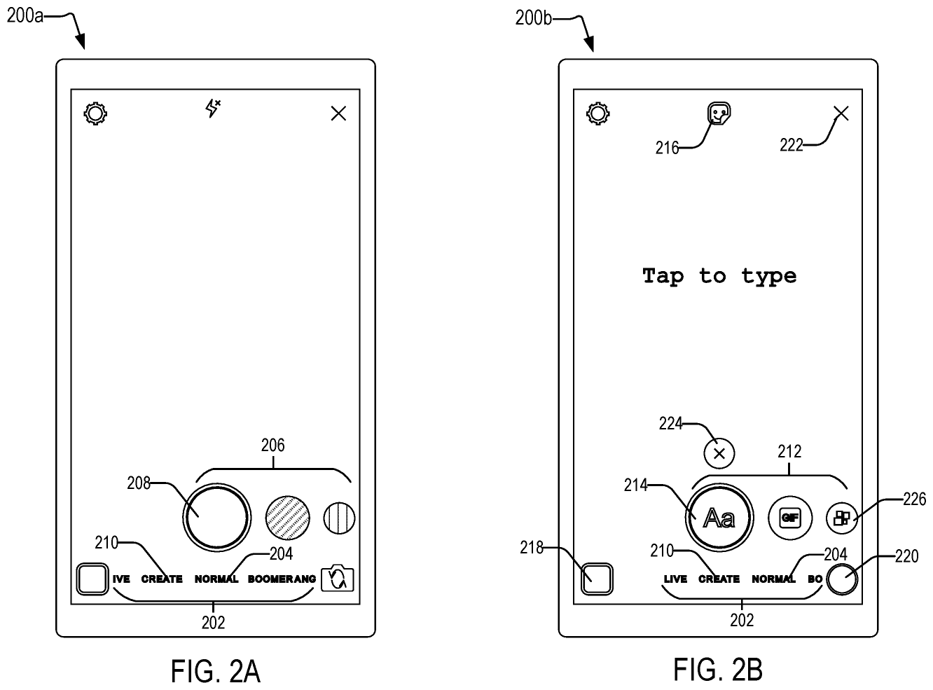

FIGS. 2A and 2B are schematic views showing example user interfaces that are usable to implement the techniques described herein for generating content to be shared between users. The interfaces and/or the notifications may be generated by a computing device of a social networking system (e.g., social networking system 106) and transmitted to one or more user computing devices (e.g., computing devices 104) for presentation, and/or the interfaces may be generated by the one or more user computing devices based at least in part on instructions received from the social networking system 106. In examples, the interfaces described herein may be implemented in the context of the system 100.

FIGS. 2A and 2B illustrate example interfaces of mode controls for an ephemeral content creation functionality. An interface 200a shown in FIG. 2A corresponds to a first user interface that may be displayed upon selection of an ephemeral content creation functionality of the social network application 112 (e.g., Stories of Instagram®). For example, the interface 200a may be displayed in response to a gesture (e.g., a horizontal swipe gesture) from a “home” screen and/or a feed of the social network application 112. In other examples, the interface 200a may be displayed by selection of a button, icon, or other control, by voice command, or by other user input.

In examples, the ephemeral content creation functionality provided by the social network application 112 may include one or more mode controls 202. Each of the one or more mode controls 202 may provide a subset of capabilities of the ephemeral content creation functionality. As shown, the mode controls 202 may be arranged in the interface 200a in a first row, e.g., generally horizontally across the interface 200a. A mode control 204 of the mode controls 202 generally in a center of the first row may be a current or “selected” mode of the ephemeral content creation functionality. In other words, the mode control 204 in the center of the first row may dictate a subset of the capabilities of the ephemeral content creation functionality that a user has currently selected to access, corresponding to the particular mode control 204. In some cases, the user 102(1) may transition between the mode controls 202 using a gesture, such as a horizontal swipe gesture, and/or by tapping a desired mode to bring the desired mode to the center of the mode control row and utilize the functionality of the desired mode control, to name a few examples.

The mode controls 202 may include a camera mode control (which may also be referred to as a normal mode control), a live video mode control, a content creation mode control (which may also be referred to as a create mode control), a boomerang mode control, a zoom mode control, a hands-free mode control, and so forth.

In examples, the create mode control may enable the user to select from content supplied by a social networking system to the social network application, as well as enable the user to customize the content supplied by the social networking system. The create mode may include various features that enable the user to create customized content, such as a text feature, a GIF feature, a template feature, an on-this-day feature, a poll feature, a question feature, a countdown feature, a quiz feature, and a Shoutout feature, to name a few examples.

In examples, the live video mode control may enable the user 102(1) to stream video to followers and engage with the followers (e.g., by viewing live comments and likes of the video, and responding to comments and/or likes as the video plays).

In examples, the boomerang mode control may enable the user 102(1) to capture a burst of images using a camera of the computing device 104(1), then speeds up the images and plays them forward and backward to create a looping “boomerang” video.

In examples, the zoom mode control may enable the user 102(1) to capture a video that includes a zoom in and/or a zoom out operation, and apply one of multiple filters to the video. The hands-free mode control may enable the user 102(1) to initiate recording a video with a tap, rather than holding a button to record, as is the case when using the normal mode control.

Additional detail regarding various mode controls associated with content creation functionalities are provided in U.S. Pat. No. 11,042,261 and in U.S. Pat. No. 11,048,384, both of which are incorporated herein by reference in their entirety.

In the example shown, the mode control 204 that is currently selected may correspond to a “normal” mode control. In some examples, the normal mode control may be a default mode control upon selection of the ephemeral content creation functionality, but other modes may be used as the default. Based on selection of the mode control 204 as the normal mode control, the social networking application 112 may display a menu 206 associated with the mode control 204 in the interface 200a. In examples, the menu 206 may include features which are each usable to generate an item of ephemeral content. For instance, a feature 208 included in the menu 206 may cause, upon selection by the user 102(1), a camera of the device 104(1) to capture an image or a video which may be used to generate the item of ephemeral content.

In some examples, the features included in the menu 206 may be arranged in the interface 200a in a second row, e.g., generally horizontally across the interface 200a and located above (e.g., closer to a top of the interface 200a). A feature of the features in the menu 206 generally in a center of the second row may be a current or “selected” feature of the mode control 204. That is, the feature 208 in the center of the second row may dictate a subset of the capabilities of the mode control 204 that a user has currently selected, corresponding to the particular feature 208. In examples, the feature in the center of the second row that is the current feature of the mode control 204 may have an indicator, such as an outline, a highlight, or may be displayed in a center of a stationary circle (or other shape) in the interface 200a. In some cases, the user 102(1) may transition between the features in the menu 206 using a gesture, such as a horizontal swipe gesture, and/or by tapping a desired feature to bring the desired feature to the center of the feature menu row and utilize the functionality of the desired feature, to name a few examples.

An interface 200b shown in FIG. 2B corresponds to a second user interface that may be displayed upon selection of a mode control 210 (e.g., Create Mode of Instagram®). For example, the interface 200b may be displayed in response to a gesture (e.g., a horizontal swipe gesture) from the mode control 204 (normal mode) to the mode control 210 (Create Mode). The mode control 204 may include a menu 212 that includes features associated with the mode control 210 arranged in a row (e.g., a horizontal configuration) above the row of mode controls 202.

Similar to the discussion above, in examples, one of the features in the menu 212 generally in a center of the second row may be a current feature of the mode control 210. That is, a feature 214 in the center of the second row may dictate a subset of the capabilities of the mode control 210 that a user may access, corresponding to the particular feature 214. The center of the second row may correspond to a center of a display screen, a center of a user interface, and/or a center relative to the other features in the menu 212. In examples, the feature in the center of the second row that is the current feature of the mode control 210 may have an indicator, such as an outline, a highlight, or may be displayed in a center of a stationary circle (or other shape) in the interface 200b. In some cases, the user 102(1) may transition between the features in the menu 212 using a gesture, such as a horizontal swipe gesture, and/or by tapping a desired feature to bring the desired feature to the center of the feature menu row and utilize the functionality of the desired feature, to name a few examples.

In some examples, the mode control 210 may include one or more controls that remain constant independent of a selected feature of the mode control 210. For instance, the mode control 210 may include an overlay control 216 that, when selected, enables the user 102(1) to add an overlay such as a sticker, a GIF, an icon, or the like, which may overlay at least a portion of the item of ephemeral content. The mode control 210 may include a content control 218 that, when selected, enables the user 102(1) to add an image and/or a video from storage accessible by the device 104(1) to the item of ephemeral content. Additionally, the mode control 210 may include a background control 220 that, when selected, enables the user 102(1) to change a color, pattern, gradient, and the like of a background of the item of ephemeral content. Further, the mode control 210 may include an exit control 222 that, when selected, exits the ephemeral content creation functionality, returning the social network application 112 to a feed or other user interface.

In some cases, the mode control 210 may include a return control 224, that, when selected, returns the menu 212 to a default feature (e.g., the feature 214). For example, the user 102(1) may select a different feature, such as a feature 226, and the social network application 112 may present functionality associated with the feature 226, as well as moving the icon associated with the feature 226 to a center of the row of the menu 212. In some examples, when the feature 226 is selected, the mode controls 202 may be hidden and/or may not be selectable. Therefore, the user 102(1) may select the return control 224 to view and/or access the mode controls 202.

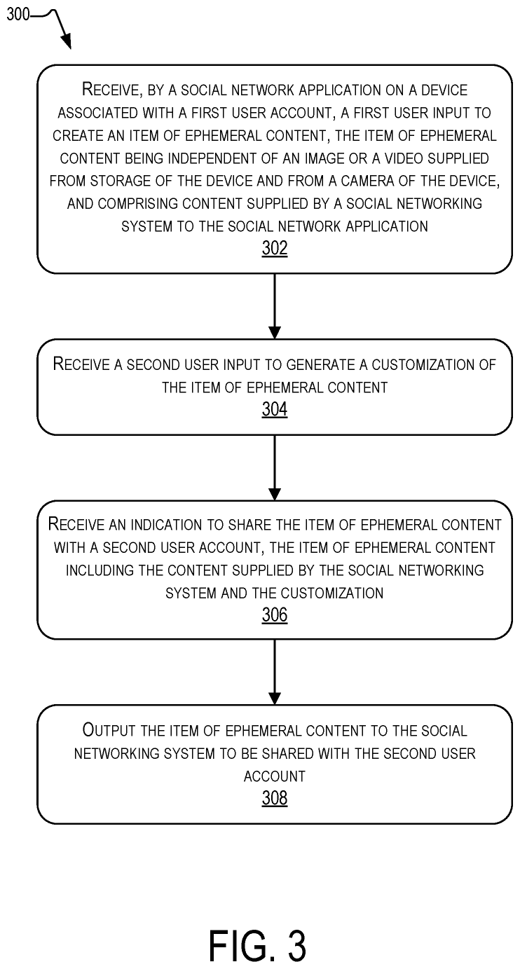

FIG. 3 illustrates an example process 300 for receiving inputs to generate an item of ephemeral content using ephemeral content creation functionality. Various methods are described with reference to the example system of FIG. 1 and/or the user interfaces of FIGS. 2A and 2B for convenience and ease of understanding. However, the methods described are not limited to being performed using the systems of FIG. 1 and/or the user interfaces of FIGS. 2A and 2B and may be implemented using systems and devices other than those described herein.

The methods described herein represent sequences of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. In some embodiments, one or more operations of the method may be omitted entirely. Moreover, the methods described herein can be combined in whole or in part with each other or with other methods.

An operation 302 includes receiving, by a social network application on a device associated with a first account associated with a first user, a first user input to create an item of ephemeral content. In examples, ephemeral content may be created by inputting and/or retrieving data using computing device 104. The item of ephemeral content may include an image or a video captured by a camera of a computing device and/or supplied from storage of the computing device or remote storage such as cloud storage. In examples, the item of ephemeral content may comprise content supplied by a social networking system to the social network application.

For example, the first user input to create the item of ephemeral content may include a selection of ephemeral content creation functionality from amongst other functionality of the social network application, where the other functionality may include displaying feed media, displaying stories media, generating original content using a camera of the computing device 104(1), and so forth. Alternatively or additionally, the first user input may include selection of a mode control of multiple mode controls 202, such as a create mode control. In some cases, the first user input may include selection of a feature from a menu 206 and/or a menu 212 of a mode control. In some examples, the item of ephemeral content comprises content supplied from the content components 118 of the social networking system 106, as described above and below.

An operation 304 includes receiving a second user input to generate a customization of the item of ephemeral content. Various customizations are described herein, but may include adding and/or altering text, changing a color of a background, moving an icon to a different location on the item of ephemeral content, selecting a particular content item from multiple content items supplied by the social networking system to include in the item of ephemeral content, adding a sticker or icon to the item of ephemeral content, and selecting another account to include with (e.g., tag) the item of ephemeral content, to name a few examples.

An operation 306 includes receiving an indication to share the item of ephemeral content including the content supplied by the social networking system and the customization with a second account. In some examples, the indication to share the item of ephemeral content may include an indication to share the item of ephemeral content with all, or multiple, of the followers of the account associated with the user 102(1). Alternatively or additionally, the indication to share the item of ephemeral content may include an indication of a subset of the followers of the account associated with the user 102(1), such as a group of designated “Close Friends” of the user 102(1), one or more individually-selected accounts, and so forth.

An operation 308 includes outputting the item of ephemeral content to the social networking system to be shared with the second account. In some examples, the social networking system 106 may distribute the item of ephemeral content to the users 102(2)-102(n) identified by the user 102(1) as part of the operation 306. When the computing devices 104(2)-104(m) display the item of ephemeral content to the users 102(2)-102(n), the social network application 112 may allow the users 102(2)-102(n) to interact with the item of ephemeral content as for example described in U.S. Pat. Nos. 11,042,261 and 11,048,384.

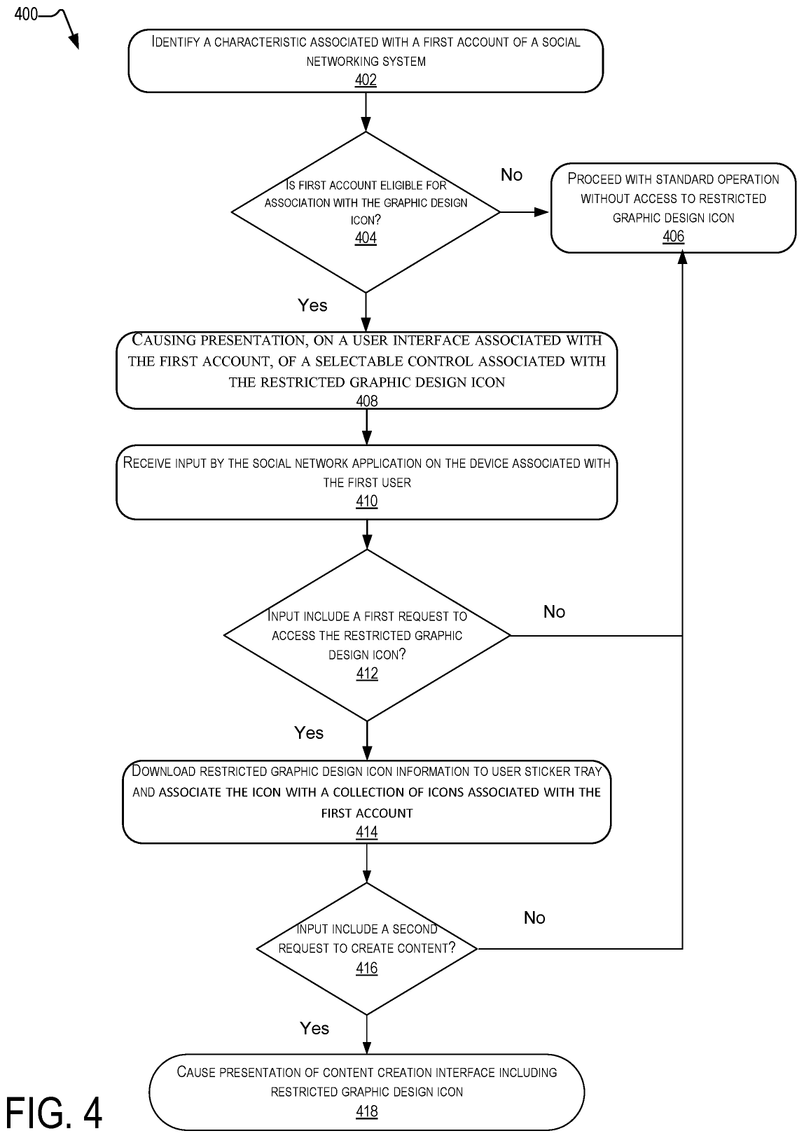

FIG. 4 illustrates an example process 400 involving the identification of characteristics for association with a restricted graphic design icon as described herein in conjunction with operation of one or more system functionalities as described for receiving inputs to generate an item of ephemeral content using ephemeral content creation functionality.

At 402 the social networking system 106 can determined whether a given account includes one or more characteristics associated with the restricted graphic design icon. In examples, social networking system 106 may determine whether a restricted graphic design icon campaign is available. In examples, the social networking system 106 may cause a call to service to be sent via an application programming interface (API) to retrieve all required information about the restricted graphic design icon campaign and user and account information.

In examples, a first account may be identified to determine if it may be associated with a restricted graphic design icon campaign. In examples, identification may be based on active status of the account. In examples, the status of a first account may be based on the social networking system 106 tracking of account status, a first input signal received by the social network application 112 provided on the user computing device 104, or any other means that may indicate that the account is active.

In examples, the social networking system 106 may determine whether the first account has already been associated with the restricted graphic design icon. In examples, where the first account has been already associated, the system may stop review of the account as access to the restricted design icon was already effectuated.

In examples, for a selected account that was not previously associated with the restricted graphic design icon, the social networking system 106 may determine one or more account characteristics based on information regarding the account. Information regarding the account may include information about the user associated with the account, information about account settings, information about interaction data associated with the account, geolocation of the computing device 104 used to access social network application 112 associated with the account, or any combination thereof.

In examples, information about the user associated with the account may include demographical information of the user. In examples, demographical information about the user may be collected at the time an account is opened. In examples, demographical information may include age, birthday, sex, ethnic or cultural background, particular interests, profession, hobbies, political affiliations, or any like information.

In examples, information about the account settings may include information about privacy settings, connections to one or more other accounts, connections with interest groups, account status, i.e. whether in good standing, degree to which content from the account is recommended to other accounts, or any other account setting.

In examples, information about interaction data associated with the account may include level of activity including current state, i.e. whether currently logged in or not, recent activity history such as time when logged in, time spent logged into the account, log in frequency, browsing history, type of activity such as browsing, creating content, commenting on other accounts contents, engagement of other network functionalities such as use of particular hashtags, other accounts followed, information regarding any engaged commercial activities, and like information.

In examples, the social networking system 106 may also gather additional information regarding the user and/or the account. For example, the social networking system 106 may be able to retrieve a geolocation of the user. The geolocation may be retrieved through a global position system or like device provided in the computing device 104 by which a user accesses the social network application 112. In examples, a characteristic may be met, for example, if the geolocation of the computing device 104 is within a threshold distance of a designated location associated with a restricted graphic design icon as may be defined by the restricted graphic design icon campaign. In examples, the social network application 112 may communicate with one or more systems within the computing device 104 and retrieve information from computing device 104. In examples, information retrievable from computing device 104 may include a geolocation. In examples, information retrievable from computing device 104 may include information relating to the operating system of the computing device 104, information regarding the hardware of computing device 104, information from one or more other applications running on computing device 104, current date and time at location of the computing device 104, or any combination thereof together or separately from the geolocation.

In examples, the social networking system 106 may also determine if a restricted graphic design icon campaign is ongoing and the characteristics to associate an account to the restricted graphic design icon. In examples, if more than one restricted graphic design icon campaigns are ongoing at the same time, the social networking system 106 may conduct a determination for association as described herein for each campaign.

In examples, a restricted graphic design icon campaign may be designed, configured, or modeled as desired. In examples, a restricted graphic design icon campaign may be associated to any type of event, geographic location, place, business, cause, group, activity, interest, topic, or any combination thereof. In examples, a restricted graphic design icon campaign may be temporal, meaning only be ongoing for a limited time period. In examples, one or more characteristics required for association with a restricted graphic design icon may be predetermined. In examples, one or more characteristics to be associated with the restricted graphic design icon may include one or more of the previously outlined information regarding an account including information about a user, account settings, interaction data associated with the account, and/or information retrievable from a computing device 104, such as for example a geolocation, a date and time, or other information.

In examples, the association of a restricted graphic design icon may be a dynamic determination. For example, a restricted graphic design icon may be associated with an event, object, person, or entity that travels through a geographic location. In examples, an account may qualify to be associated with the restricted graphic design icon when the social networking system 106 determines the user associated with the account is in the same geographic location as the event, object, person, or entity associated with the restricted graphic design. In examples, an account may qualify to be associated with the restricted graphic design icon when the social networking system 106 determines the user associated with the account is the same geographic location within a threshold time period of when the event, object, person, or entity associated with the restricted graphic design icon is there. In examples, the social networking system 106 may dynamically activate and deactivate access to the restricted graphic design icon as the event, object, person, or entity associated with the restricted graphic design icon moves from one location to the next.

In examples, the social networking system 106 may compare one or more characteristics associated with an account with those associated with the restricted graphic design icon. In examples, the social networking system 106 may require a match in characteristics to be above a given threshold. In examples, all characteristics of the restricted graphic design icon must be met to provide an association between an account and the restricted graphic design icon. In examples, at least one characteristic must be met for the association. In examples, a subset of the characteristics must be met for the association to be established.

At 404 the social networking system 106 makes the determination based on matched characteristics as to whether a first account is eligible for association with the restricted graphic design icon. In examples, an account becomes associated to the restricted graphic design icon if the social networking system 106 determines that the account is eligible for association. For example, an account may be associated with a restricted graphic design icon if the account is active during an ongoing campaign, and the social networking system 106 determines that the computing device 104 associated with the social network application 112 associated to that account is located in a qualifying geographical location. By way of further example, an account may be associated with a restricted graphic design icon if during the ongoing campaign of the restricted graphic design icon the first account is associated with a second account that is associated with the restricted graphic design icon. By way of an additional example, an account may be associated with a restricted graphic design icon where a demographic characteristics of the user, such as falling within a predetermined age group, associated with that account matches an intended demographics for an ongoing restricted design icon campaign. These are mere examples, and it should be understood that any combination of information previously described may be used to determine association between an account and a restricted graphic design icon for any one or more ongoing campaigns.

If the system determines that the account is not eligible for association with the restricted graphic design icon for an ongoing campaign, then the process may continue to 406 where standard operation continues in which the account may interact with the social networking system 106 via social network application 112 in the usual manner without an option to create content associated with a restricted graphic design icon.

If, on the other hand, the social networking system 106 determines at 404 that the account is eligible for association, the account may be associated with the restricted graphic design icon for an ongoing campaign and the process moves to operation 408. Based on the determination that an association may be present, the social networking system 106 may cause at 408 presentation, on a user interface associated with the account, of a selectable control associated with the restricted graphic design icon.

In examples, the selectable control may be presented by any available means available to social networking system 106. In examples, the selectable control may be presented at a home screen of social network application 112, in a newsfeed provide via social network application 112, on a post from another account being viewed via social network application 112, in a direct message sent to the account via social network application 112, in a special notification provided via social network application 112, for example, as an alert icon provided on the display of computing device 104 associated with the social network application 112 for that account, or any combination thereof and any other like means.

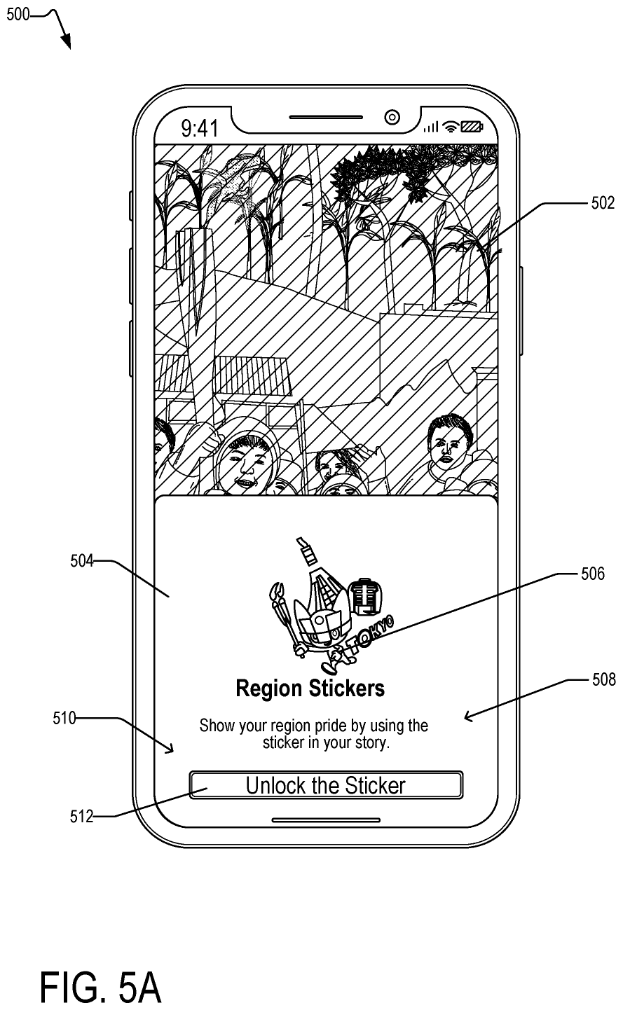

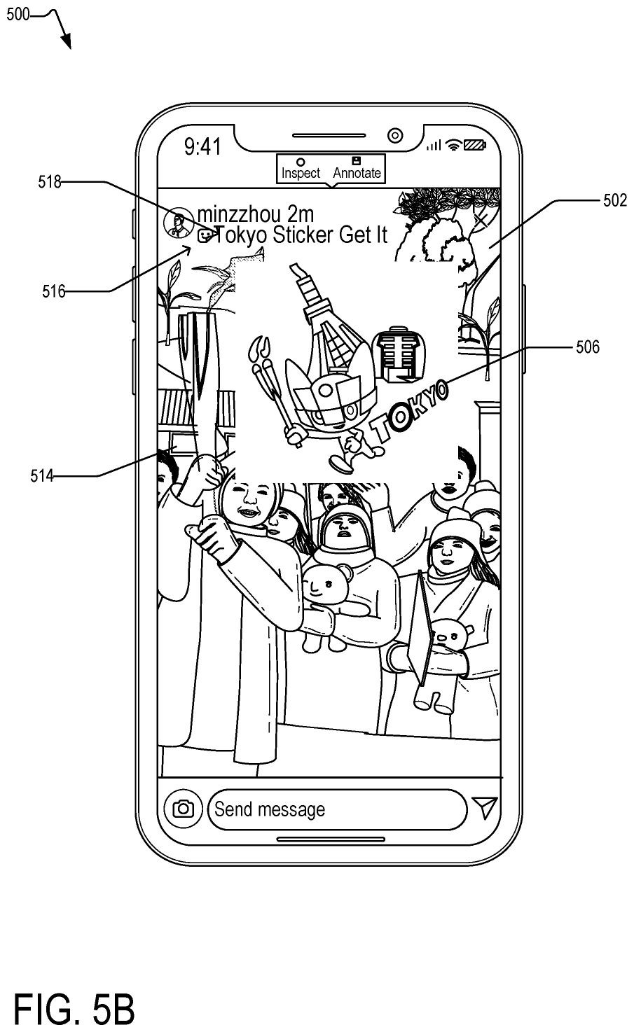

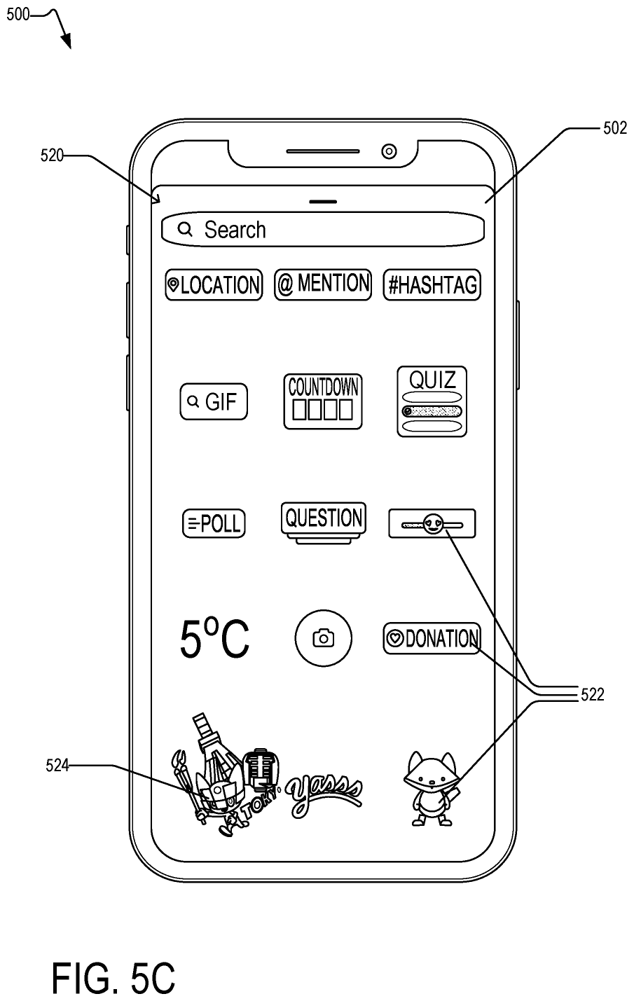

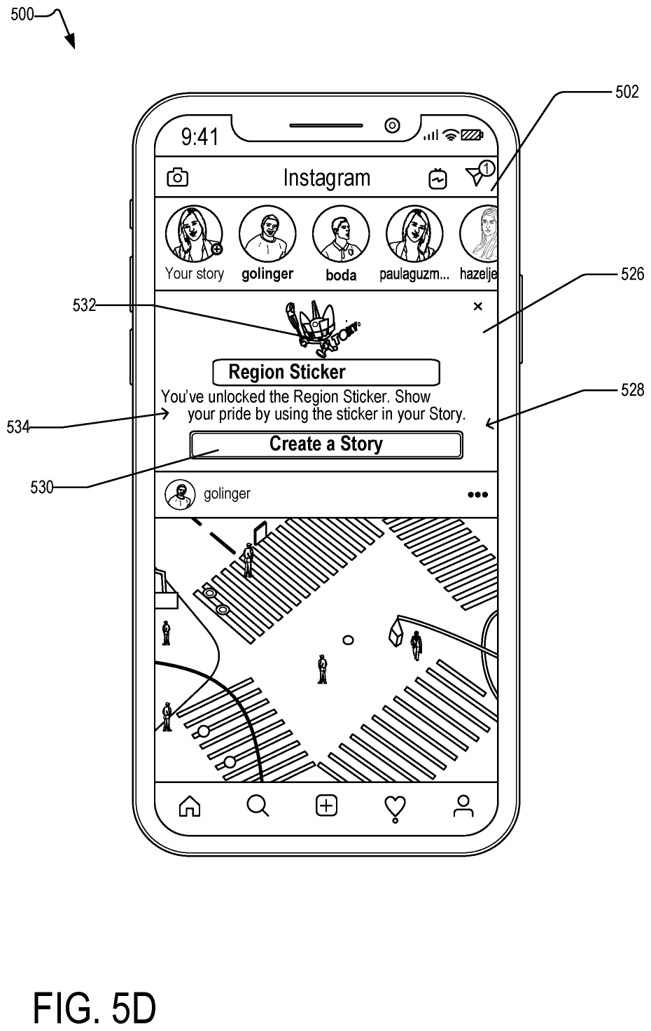

FIG. 5A illustrates an example of a selectable control that social networking system 106 may cause to be presented on a user interface. In examples, a user computing device 104 running a social network application 112 is illustrated a device 500 having a display 502.

In examples, the device 500 may be a portable computing device. In examples, a portable computing device may include a mobile phone, a laptop, a smart watch, tablet, or any like device. In examples device 500 may be a non-portable computing device such as a desktop computer or like device. In examples, computing device 500 may be integrated into a larger system such as a land vehicle, water vessel, air vehicle, building, home, appliance, or any like structure or objects.

In examples, a social networking system 106 may cause social network application 112 to present the user with a notification 504 including a selectable control. In examples, the notification 504 may include an illustration of the restricted graphic design icon 506. In examples, the notification 504 may include a message 508 identifying and/or encouraging a user to interact with the selectable control 510. In examples, the selectable control 510 may include an interactive feature 512. In examples, interaction with interactive feature 512 may be effectuated via any means made available by the computing device. In examples, as shown, the computing device 500 may be a portable device, such as a mobile phone. In examples, the computing device may include a touchscreen, a mouse, a keyboard, voice command module with accompanying software and hardware configured to receive and execute a voice command, visual recognition input device such as a camera and accompanying software that is configured to receive and execute a visual command, or any combination thereof. In the illustrated example, the device 500 may include a touchscreen thereby allowing for interaction with the interactive feature 512 of the selectable control by touching display 502 at an area proximate to or within a predetermined threshold distance above the displayed interactive feature 512.

FIG. 5B illustrates another example of a selectable control that social networking system 106 may cause to be presented on a user interface. FIG. 5B illustrates a similar device 500 having a display 502. In examples, the selectable control may be displayed in conjunction with a posted content from another account. Illustrated in FIG. 5B, display 502 of device 500 may show content posted by a different account that is already associated with restricted graphic design icon. As shown, the posted content 514 may have been modified by the restricted graphic design icon 506 in that restricted graphic design icon 506 is part of the content, such as a picture, created via the other account. In examples, having determined that the account associated with device 500 may be associated with the restricted graphic design icon, social networking system 106 may cause via social network application 112 running on device 500 to present a selectable control 516 including interactive feature 518 “Tokyo Sticker Get It”. In examples, interactive feature 518 may be an attribution link. In examples, selection of interactive feature 518, may cause presentation of notification 504 and its functionalities as described with reference to FIG. 5A.

In examples, the notification and presentation of a selectable control to a user via social network application 112 as described above may continue to be provided one on or more screens of social network application 112 until the user interacts with the selectable control, until the restricted graphic design icon campaign ends, or a combination of both. In examples, the notification associated with the selectable control as described may include an ignore option to delete the notification without selection. In examples, the ignore option may include a separate interactive feature, for example an “X” icon, that may be selected via social network application 112 in the same manner as described for the interactive feature of the selectable option.

Turning back to FIG. 4, after presenting the selectable control, the social networking system 106 may await input via the social network application 112 at operation 410. The input received at 410 may be any input signal that may be received by social network application 112. In examples, the input may be associated with the selectable control. In examples, the input may not be associated with the selectable control. In examples, the input may be associated with a social network functionality that is not related to the selectable control.

At 412, the social networking system 106 determines whether an input was received via social network application 112 and, if so, whether the input includes a first request to access the restricted graphic design icon via interaction with the selectable control. In examples, as previously described, the interaction with the selectable control may be effectuated via one or more interactive features that are included in the selectable control.

In examples, the input received at 410 may not be associated with the selectable control and thus may not be considered as a request to access the restricted graphic design icon. If examples, when the input received at 410 is not a request to access the restricted graphic design icon, at 412 the social networking system 106 via social network application 112 continues in accordance with standard operation to carry out any other requested function at 406.

In examples, the input received at 410 may be associated with the selectable control. In examples, at 412 the social networking system 106 may determine that the input received at 410 is a request to access the restricted graphic design icon. In examples, based on the determination at 412 that a request has been made the process may continue to operation 414.

In examples, at operation 414, in response to a request to access the restricted graphic design icon, the social networking system 106 may cause the graphic design icon information, including the meta data, to be downloaded onto a sticker tray associated with that account. In examples, the restricted graphic design icon may be associated with a collection of other icons associated with the account. In examples, a sticker tray may be a storage location that stores all stickers for that account. In examples, the sticker tray may be configured to store general stickers and one or more restricted graphic design icons.

FIG. 5C illustrates an example of a sticker tray onto including one or more unrestricted stickers and at least one restricted graphic design icon. As illustrated, FIG. 5C shows a device 500 as previously described with a display 502. In examples, social network application 112 may be configured to include a functionality that allows a user access to the sticker tray 520 of the account associated with the user. In examples, the sticker tray information for an account may be stored remotely and accessed via social networking system 106. In examples, the sticker tray information for an account may be stored locally onto a memory of computing device 104 such as device 500. In examples, the sticker tray information for an account may be stored both remotely and locally. In examples, the sticker tray screen 520 may display one or more stickers 522, one or more restricted graphic design icons 524, or a combination of both. In examples, each item shown in the sticker tray may be selected for association with created content. In examples, selection of the restricted graphic design icon may allow for creation of modified content as described herein.

Turning back to FIG. 4, in examples, optionally, at operation 414 the social networking system 106 may also present a second notification with a second selectable control that if selected can trigger one or more creation functionalities coupled to the restricted graphic design icon.

FIG. 5D illustrates an example of the optional second notification with second selectable control. FIG. 5D illustrate a device 500 with a display 502 as previously described. In examples, a second notification 526 including a second selectable control 528. In examples, the selectable control 528 may include an interactive feature 530 that may be selected in the same manner as described for other interactive features discussed herein. In examples, interactive feature 530 may be selected by a gesture via a touchscreen provided in device 500. In examples, as shown, the second selectable control 528 may include an image of the restricted graphic design icon 532, and additional information 534 such as identification information of the icon and/or a notification for the account to communicate that association (i.e. “unlocking”) for the restricted graphic design icon has been effectuated and that the icon is ready for use.

Turning back to FIG. 4, at 416 the social networking system 106 determines if the input received via social network application 112 includes a second request to create content to be modified by the restricted graphic design icon. In examples, the social networking system 106 determines that the input is not associated with a request to create content to be modified by the restricted graphic design icon. As such, the process may proceed to 406 and the system continues with standard operation.

In examples, at 416 the social networking system 106 determines that the input received via social network application 112 is associated with a request to create content to be modified by the restricted graphic design icon and may proceed to operation 418. In examples, operation 416 may be optional and the process can directly move from 414 to 418 in response to a request to access the restricted graphic design icon.

At operation 418 the social networking system 106 via social network application 112 may activate one or more content creation interface that may include one or more content creation functionalities modified by and/or including the restricted graphic design icon. In examples, the one or more content creation functionalities may include one or more functionalities as previously described including image and/or video capturing mode, create mode, or any other functionality as described. In examples, a user may be provided with the selection of a desired mode for the content creation functionality, as for example described earlier with respect to FIGS. 2A and 2B and/or as described in U.S. Pat. Nos. 11,042,261 and 11,048,384.

In examples, at operation 418, the content creation functionalities may be modified by the inclusion of the associated restricted graphic design icon. In examples, the content creation functionalities modified by the inclusion of the associated restricted graphic design icon may be used to create modified content as described in more detail below.

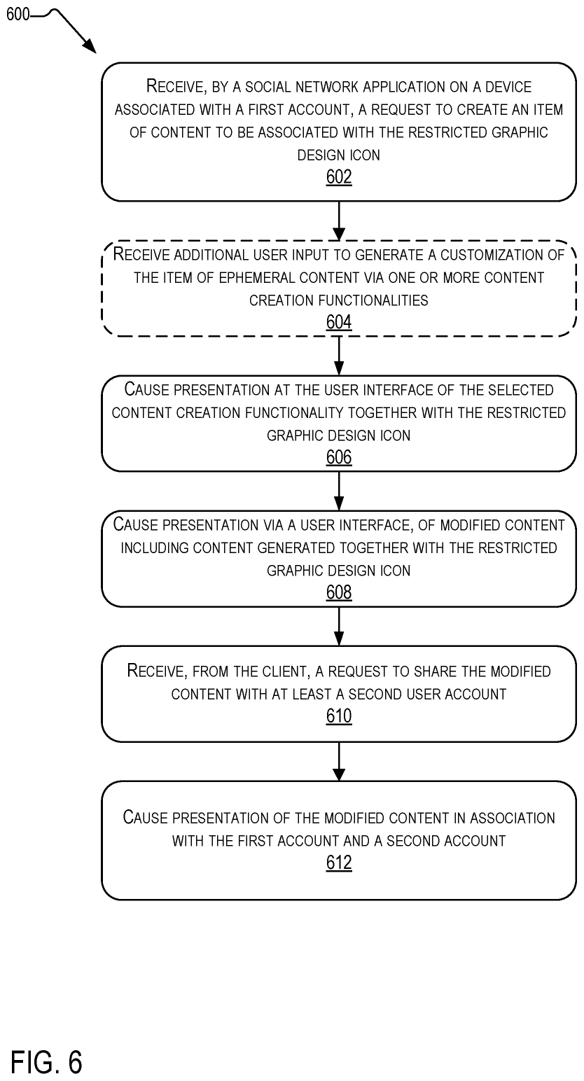

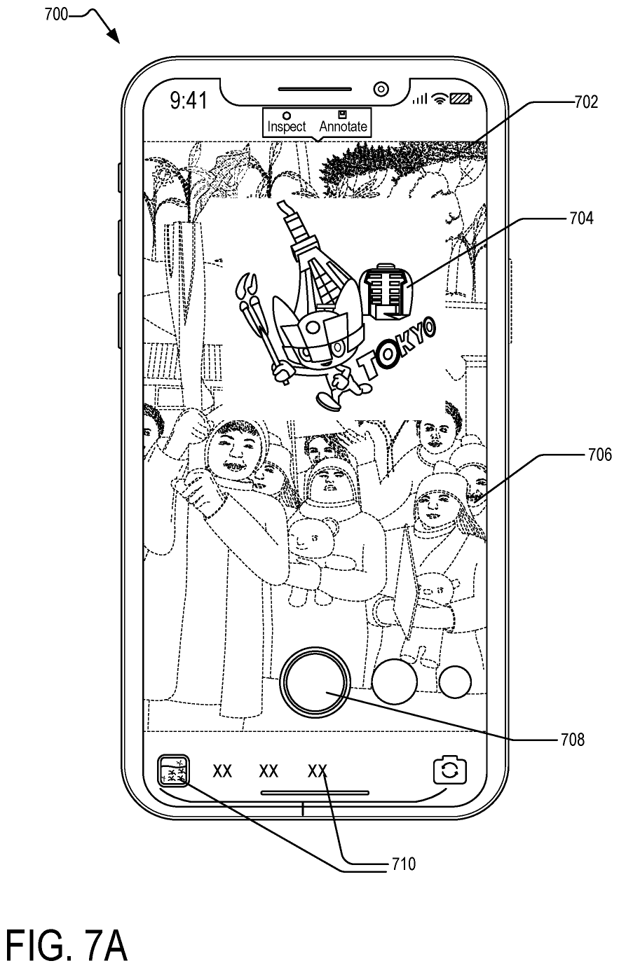

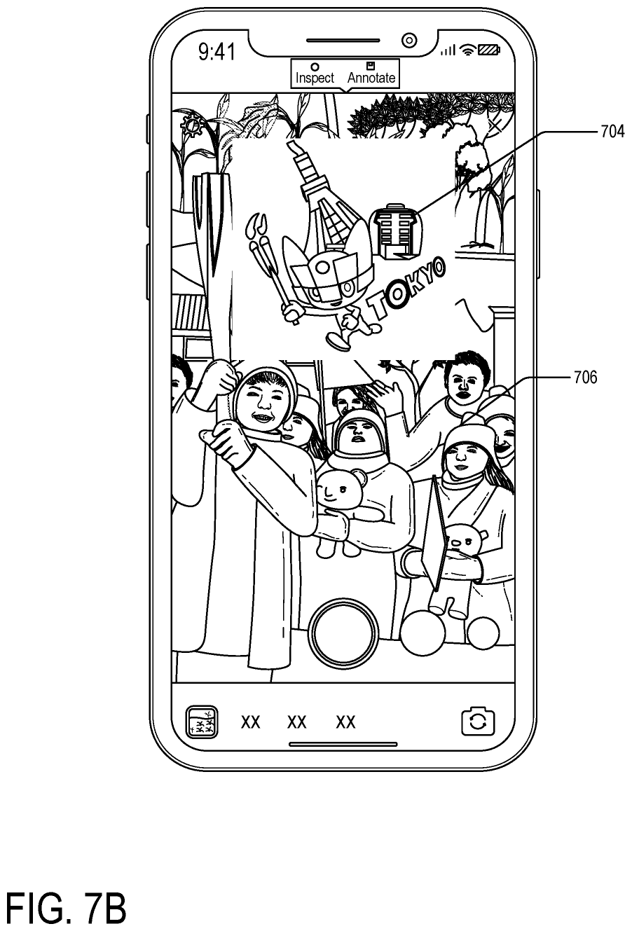

FIGS. 6 and 7A-7B illustrate an example process and examples of content creation functionality associated with a restricted graphic design icon. As described earlier, the described process may be engaged in conjunction with operation 418 from FIG. 4, by initiating content creation associated with the restricted graphic design icon from selecting the restricted graphic design icon from a sticker tray, or by any other functionality that may be provided via social network application 112 configured to trigger the creation of content associated with a restricted graphic design icon that has been associated with the account.

As illustrated at FIG. 6, process 600 may be triggered at 602 by the receipt of a request via the social network application 112 running on a computing device 104 associated with a first account. In examples, the request may be to create content to be associated with the restricted graphic design icon.

In examples, upon receipt at 602 of the request to create content to be associated with or including the restricted graphic design icon, optionally at 604 the social networking system 106 by way of social network application 112 may receive an additional content customization input selecting one or more content creation functionalities as previously described.

In examples, at operation 606, social networking system 106 and/or social network application 112 may cause presentation at a user interface, such as a display screen with touchscreen capabilities and/or coupled to one or more input devices such as a keyboard, command dials, voice command module, visual command module or any combination thereof, a content creation functionality mode together with the associated restricted graphic design icon.

In examples, the content creation functionality may be presented on the user interface coupled to the associated restricted graphic design icon. In examples, the restricted graphic design icon may be populated into the content creation functionality. In examples, the restricted graphic design icon may be displayed simultaneously with the display of one or more content creation functionalities. For example, if the content creation functionality is an image or video capturing mode, the restricted graphic design icon may be shown on the screen during preview mode, capturing mode, or post creation mode. Similarly, the restricted graphic design icon may be provided during a create mode including a text box or other content creation functionality modes.

FIG. 7A illustrates an example of a content creation functionality mode modified by the restricted graphic design icon associated thereto. FIG. 7A illustrates a computing device 104 as device 700 with a display 702 as previously described for device 500 and display 502. In examples, the content creation functionality may be an image and/or video capturing mode. In examples, as shown, the restricted graphic design icon 704 may be shown while the content creation functionality is still in preview mode. For purposes of illustration only, in FIG. 7A by the image being captured 706 is shown in broken lines to convey that the camera is still in preview mode. In examples, during preview mode, the content creation functionality in image or video capture mode may also display an interface icon 708 to start and stop recording and/or to snap a picture. In examples, one or additional functionality options 710 may also be provided to allow a user to additional options with the creation and or characterization of the content being created. In examples, the restricted graphic design icon may automatically appear after the image or video is captured. In examples, the restricted graphic design icon may be added after the image or video is captured.

In examples, other content creation functionalities may be coupled to a restricted graphic design icon in a similar manner as illustrated in FIG. 7A. For example, if the creation mode is a text box, the restricted graphic design icon may be displayed in the text box before, while, or after the text is entered. Similar coordination of the associated restricted graphic design icon may be arranged for any other content creation functionality or mode thereof.

In examples, a displayed restricted graphic design icon may be displaced on the screen. In examples, the displayed restricted graphic design icon may include an interactive feature that allows for the selection and relocation of the restricted graphic design icon. In examples, interaction with the interactive feature may be effectuated in any means as described herein for any of the interactive features. In examples, the computing device 104 may include a device 700 as illustrated in FIG. 7A, which device 700 may include a touchscreen as display 702. In examples, a gesture over or within a threshold distance of the restricted graphic design icon may be recorded as a selection of the displacement interactive feature. In examples, the restricted graphic design icon may be configured so that when the displacement interactive feature is selected, the restricted graphic design icon may be dragged or otherwise displaced across display 702 as may be desired.

Turning back to FIG. 6, in examples, once the content has been created via the one or more content creation functionalities, social networking system 106 and/or social network application 112 may cause presentation via a user interface of a modified content at 608. In examples, modified content 608 may include the content created via the one or more content creation functionalities modified by the incorporation of the restricted graphic design icon. For example, as shown in FIG. 7B, a modified content may include the image captured 706 via the content creation functionality in image capture mode shown in FIG. 7A with the restrict graphic design icon 704 incorporated therein. In examples, the restricted graphic design icon may appear where it was positioned at the time the content was created. In examples, the restricted graphic design icon may be displaced before the content is created, while content is being created, or after content has been created.

In examples, in generating the modified content the social networking system 106 and/or social network application 112 may also associated with the modified content one or more additional features. In examples, the social networking system 106 and/or social network application 112 may also associate with the modified content an attribution link associated with the restricted graphic design icon, a hashtag link associated with the restricted graphic design icon as described herein, or a combination of both.

In examples, social network application 112 may present the user with one or more additional content creation functionalities to further modify the modified content. In examples, the social network application 112 may present the user with one or more options to add one or more non-restricted stickers, additional restricted graphic design icons, apply visual effects, apply filters, add text or graphics, insert other content, or any combination thereof as described above, and/or as further described in U.S. Pat. Nos. 11,042,261 and 11,048,384.

In examples, once the modified content is finalized, at 610 the social networking system 106 by way of social network application 112 may receive from the client, i.e. the first account that generated the modified content, a command to post or share the modified content with one or more other accounts that may be associated with other users. In examples, the command to share may be in input received by social network application 112 via computing device 104. In examples, the request to post or share the modified content may include a request to post the modified content in association with a newsfeed, a user profile of the first user, a home screen, and/or a story comprising ephemeral content. In examples, the input received by the social network application 112 associated with a request to post or share the modified content may include a receipt of a request to post the modified content in association with a newsfeed, a user profile of the first user, a home screen, and/or a story comprising ephemeral content. In examples, receipt of such requests associated with the sharing or posting of a modified content may be received via one or more functionalities provided via social network application 112 in accordance with standard operating protocol and/or as described herein. In response to such request, at operation 612, the social networking system 106 causes the modified content to be shared with one or more other accounts via network 108. In examples, the other accounts may be associated with one or more users not associated with the first account that generated the modified content.

In examples, the restricted graphic design icon may be accessible and/or be associated with an account for a predetermined period of time. In examples, a restricted graphic design icon campaign may be set to expire after a given date and/or time. In examples, the social networking system 106 may track which accounts are associated with a restricted graphic design icon. In examples, a restricted graphic design icon campaign may be set to expire after a threshold number of accounts have been associated with it. In examples, other factors may be used to determine duration of a restricted graphic design icon campaign. For example, the campaign may be set to start and/or end based on the start and/or conclusion of an event. For example, the event may be sporting event such as the Olympics, a commercial event such as a store opening or a commercial exhibition, a political event such as an election campaign, a social awareness event, or any other type of event.

In examples, after conclusion of the restricted graphic design icon campaign, the accounts may no longer be associated with the restricted graphic design icon. In examples, after conclusion of a campaign, the social networking system 106 may no longer make available a selectable control to engage an association with a restricted graphic design icon. In examples, modified content created while the restricted graphic design icon is made available may remain and continued to be shared. In examples, social networking system 106 and/or social network application 112 may preclude or no longer provide content creation functionality associated with the restricted graphic design icon. As such, in examples, no additional modified content may be created in association with the restricted graphic design icon after expiration of the restricted graphic design icon campaign.

In examples, upon expiration of a restricted graphic design icon campaign, social networking system 106 and/or social network application 112 may cause removal of the restricted graphic design icon from one or more sticker trays associated with accounts that have been associated with the restricted graphic design icon. In examples, the removal may be automatic. In examples, removal may be carried out via an API. In examples, social network application 112 may present a user with a notification that a restricted graphic design icon is no longer available, or that it may become unavailable after a certain date. The notification may be provided in any means available to the social network application 112 via user interface at computing device 104. In examples, the notification that a restricted graphic design icon has or may become unavailable may be triggered by social networking system 106 and/or by restricted graphic design icon manager 124.

In examples, the restricted graphic design icon may be provided with one or more interactive features separate from creating modified content. In examples, the restricted graphic design icon may include the previously described interactive feature that may displacement of the restricted graphic design icon across a display. In examples, the restricted graphic design icon may include an interactive feature to modify its size, color, and/or appearance.

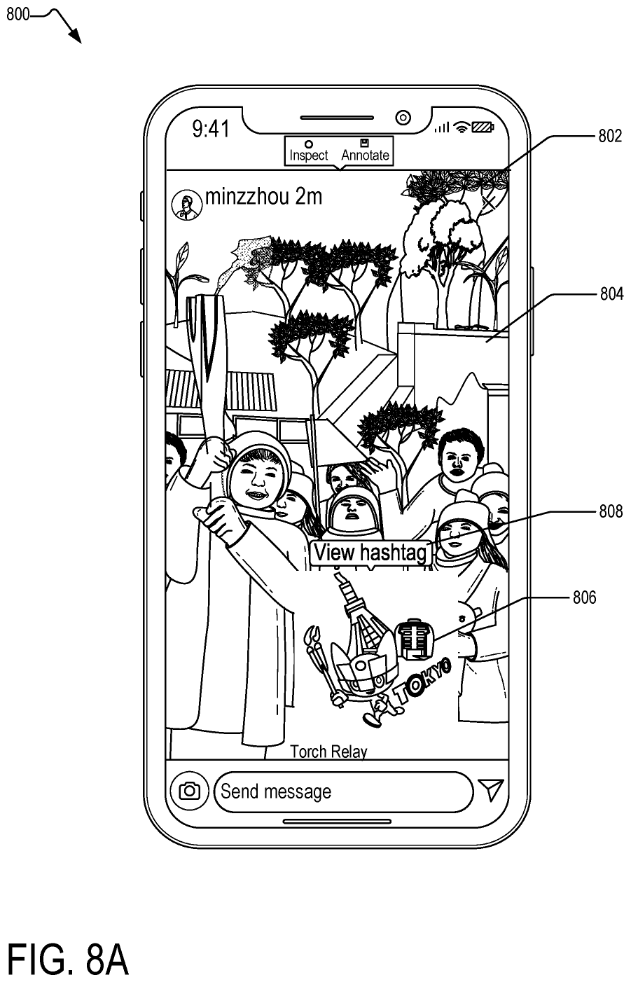

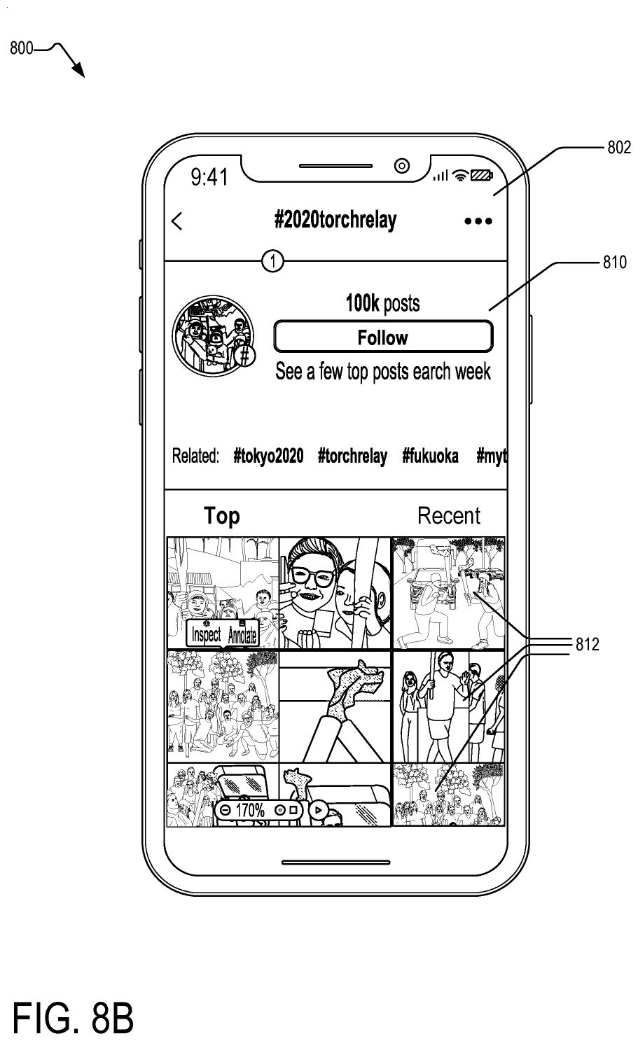

In examples, the restricted graphic design icon may include an interactive feature that may include a hyperlink. For example, as illustrated in FIG. 8A, a restricted graphic design icon may be associated with a hashtag. In examples, as illustrated, a computing device 104, shown as 800 with a display 802 as similarly described earlier with respect to 500 and 502 in FIGS. 5A-5D, may display a posted modified content 804 from an account associated with a restricted graphic design icon. As illustrated, the modified content 804 may include the restricted graphic design icon 806. In examples, a notification 808 of the presence of an associated hashtag may be presented to a user. In examples, notification 808 may include an interactive feature associated with the hashtag. In examples, in response to an interaction with a hashtag interactive feature including in notification 808 associated with a restricted graphic design icon 806, social networking system 106 may cause social network application 112 to display a content page 810 including a collection of one or more contents 812 associated with that hashtag from notification 808 as for example illustrated in FIG. 8B.

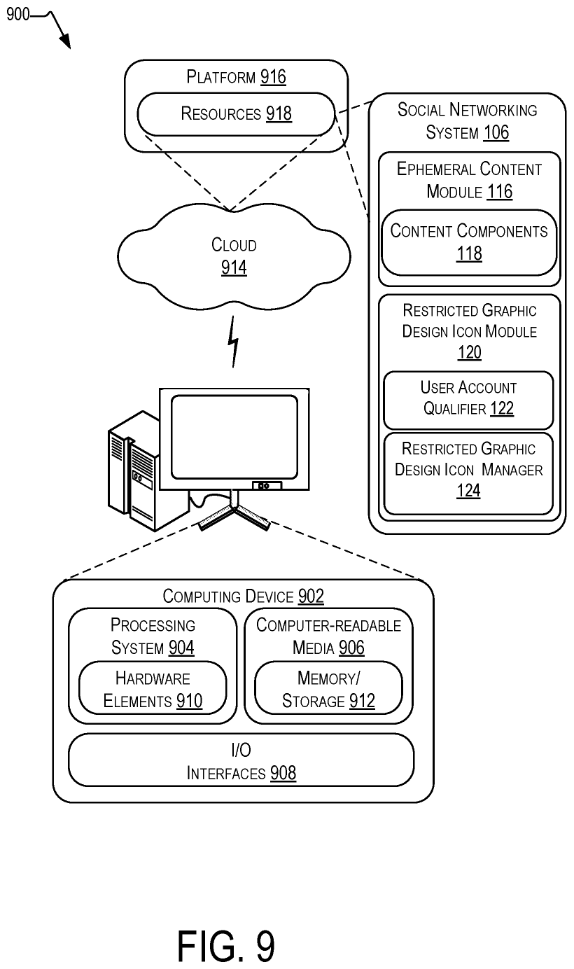

FIG. 9 illustrates an example system generally at 900 that includes an example computing device 902 that is representative of one or more computing systems and/or devices that may implement the various techniques described herein. For example, a computing device 902 may be used as a computing device 104. This is illustrated through inclusion of the social networking system 106, the ephemeral content module 116, with content components 118, and the restricted graphic design icon module 120 with account qualifier 122, and restricted graphic design icon manager 124. The computing device 902 may be, for example, a server of a service provider, a device associated with a client (e.g., a client device), an on-chip system, and/or any other suitable computing device or computing system.

The example computing device 902 as illustrated includes a processing system 904 (e.g., one or more processors), one or more computer-readable media 906, and one or more I/O interface 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed, or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 906 is illustrated as including memory/storage 912. The memory/storage 912 represents memory/storage capacity associated with one or more computer-readable media. The memory/storage component 912 may include volatile media (such as random access memory (RAM)) and/or nonvolatile media (such as read only memory (ROM), Flash memory, optical disks, magnetic disks, and so forth). The memory/storage component 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “logic,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on and/or transmitted across some form of computer-readable media. The computer-readable media may include a variety of media that may be accessed by the computing device 902. By way of example, and not limitation, computer-readable media may include “computer-readable storage media” and “computer-readable transmission media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and nonvolatile, removable and non-removable media and/or storage devices implemented in a method or technology suitable for storage of information such as computer-readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable transmission media” may refer to a medium that is configured to transmit instructions to the hardware of the computing device 902, such as via a network. Computer-readable transmission media typically may transmit computer-readable instructions, data structures, program modules, or other data in a modulated data signal, such as carrier waves, data signals, or other transport mechanism. Computer-readable transmission media also include any information delivery media. The term “modulated data signal” means a signal that has one or more of its characteristics set or changed in such a manner as to encode information in the signal. By way of example, and not limitation, computer-readable transmission media include wired media such as a wired network or direct-wired connection, and wireless media such as acoustic, radio frequency (RF), infrared, and other wireless media.

As previously described, hardware elements 910 and computer-readable media 906 are representative of modules, programmable device logic and/or device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of a module that is executable by the computing device 902 as software may be achieved at least partially in hardware, e.g., through use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

The techniques described herein may be supported by various configurations of the computing device 902 and are not limited to the specific examples of the techniques described herein. This functionality may also be implemented all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 may include applications and/or data that can be utilized while computer processing is executed on servers that are remote from the computing device 902. Resources 918 can also include services provided over the Internet and/or through a subscriber network, such as a cellular or Wi-Fi network.

The platform 916 may abstract resources and functions to connect the computing device 902 with other computing devices. The platform 916 may also be scalable to provide a corresponding level of scale to encountered demand for the resources 918 that are implemented via the platform 916. Accordingly, in an interconnected device embodiment, implementation of functionality described herein may be distributed throughout multiple devices of the system 900. For example, the functionality may be implemented in part on the computing device 902 as well as via the platform 916 which may represent a cloud computing environment 914.

Although the discussion above sets forth example implementations of the described techniques, other architectures may be used to implement the described functionality, and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. A method comprising:
providing, by a social networking system, a restricted graphic design icon configured for association with a content item to be shared via the social networking system, wherein the restricted graphic design icon includes an identifier;
identifying a characteristic associated with a first account of the social networking system;
determining, based at least in part on the characteristic, that the first account is eligible for association with the restricted graphic design icon;
based at least in part on determining that the first account is eligible for association with the restricted graphic design icon, causing presentation of a selectable control associated with the restricted graphic design icon;
based at least in part on receiving an indication of a selection of the selectable control by the first account, causing presentation, via a computing device associated with the first account, of the restricted graphic design icon in association with the content item to be posted via the social networking system;
receiving a request to share the content item including the restricted graphic design icon to a second account of the social networking system;
causing presentation, via a computing device associated with the second account, of the content item including the restricted graphic design icon and a selectable control associated with the identifier associated with the restricted graphic design icon;
receiving, from the second account of the social networking system, an indication of a selection of the selectable control associated with the identifier associated with the restricted graphic design icon; and
causing presentation, to the second account of the social networking system, of a restricted graphic design icon interface, wherein the restricted graphic design icon interface includes one or more additional content items shared to the social networking system, wherein the one or more additional content items include the restricted graphic design icon.

2. The method of claim 1, wherein identifying the characteristic associated with a first account comprises receiving information associated with the first account, the information comprising at least one of:
user information associated with the first account;
account setting associated with the first account;
interaction data associated with the first account; or
a location of the computing device associated with the first account.

3. The method of claim 1, wherein determining that the first account is eligible for association with the restricted graphic design icon comprises determining that a location of the computing device associated with the first account is within a threshold distance of a designated location.

4. The method of claim 1, wherein selectable control associated with the restricted graphic design icon is presented via at least one of:
home screen,
a newsfeed, or
an attribution link associated with a second content item.

5. The method of claim 1, wherein the restricted graphic design icon is presented in content creation interface comprising at least one of:
an image capture mode control, or
a text box.

6. The method of claim 5, wherein:
the content creation interface comprises the image capture mode control,
the content item comprises an image, and
the restricted graphic design icon is presented in association with the image in a preview mode of the content creation interface prior to capturing the image.

7. The method of claim 6, wherein the restricted graphic design icon is presented in association with a first portion of the image, the method further comprising:
receiving an input to associate the restricted graphic design icon with a second portion of the image; and
in response to the input, associating the restricted graphic design icon with the second portion of the image in the preview mode.

8. The method of claim 1, wherein the identifier associated with the restricted graphic design icon includes at least one of:
an attribution link; or
a hashtag.

9. The method of claim 1, wherein receiving the request to share the content item including the restricted graphic design icon further comprises receiving a request to share the content item including the restricted graphic design icon in association with at least one of:
a newsfeed,
a user profile associated with the first account,
a home screen, or
a story.

10. A system comprising:
one or more processors; and
one or more computer-readable media storing instructions that, when executed by the one or more processors, cause the one or more processors to perform operation comprising:
providing, by a social networking system, a restricted graphic design icon configured for association with a content item to be shared via the social networking system, wherein the restricted graphic design icon includes an identifier;
identifying a characteristic associated with a first account of the social networking system;
determining, based at least in part on the characteristic, that the first account is eligible for association with the restricted graphic design icon;
based at least in part on determining that the first account is eligible for association with the restricted graphic design icon, causing presentation of a selectable control associated with the restricted graphic design icon;
based at least in part on an indication of a selection of the selectable control by the first account, causing presentation, via a computing device associated with the first account, of the restricted graphic design icon in association with the content item to be posted via the social networking system;
receiving a request to share the content item including the restricted graphic design icon to a second account of the social networking system;
causing a presentation, via a computing device associated with the second account, of the content item including the restricted graphic design icon and a selectable control associated with the identifier associated with the restricted graphic design icon;
receiving, from the second account of the social networking system, an indication of a selection of the selectable control associated with the identifier associated with the restricted graphic design icon; and
causing presentation, to the second account of the social networking system, of a restricted graphic design icon interface, wherein the restricted graphic design icon interface includes one or more additional content items shared to the social networking system, wherein the one or more additional content items include the restricted graphic design icon.

11. The system of claim 10, wherein identifying the characteristic associated with the first account is based at least in part on one or more of:
user information associated with the first account,
account settings associated with the first account,
interaction data associated with the first account, or
location data of a computing device associated with the first account.

12. The system of claim 10, wherein the selectable control associated with the restrictive graphic design icon is presented via at least one of:
a home screen,
a newsfeed, or
an attribution link associated with a second content item.

13. The system of claim 10, the operations further comprising:
presenting, to the first account via the computing device associated with the first account, one or more controls associated with content creation functionality,
wherein the one or more controls associated with content creation functionality and the restricted graphic design icon are presented prior to a generation of the content item.

14. The system of claim 10, wherein the identifier associated with the restricted graphic design icon includes at least one of:
an attribution link; or
a hashtag.

15. One or more non-transitory computer-readable media storing instructions that, when executed by one or more processors, cause the one or more processors to perform operations comprising:
providing, by a social networking system, a restricted graphic design icon configured for association with a content item to be shared via the social networking system, wherein the restricted graphic design icon includes an identifier;
identifying a characteristic associated with a first account of the social networking system;
determining, based at least in part on the characteristic, that the first account is eligible for association with the restricted graphic design icon;
based at least in part on determining that the first account is eligible for association with the restricted graphic design icon, causing presentation of a selectable control associated with the restricted graphic design icon;
based at least in part on an indication of a selection of the selectable control by the first account, causing presentation, via a computing device associated with the first account, of the restricted graphic design icon in association with the content item to be posted via the social networking system;
receiving a request to share the content item including the restricted graphic design icon to a second account of the social networking system;
causing a presentation, via a computing device associated with the second account, of the content item including the restricted graphic design icon and a selectable control associated with the identifier associated with the restricted graphic design icon;
receiving, from the second account of the social networking system, an indication of a selection of the selectable control associated with the identifier associated with the restricted graphic design icon; and
causing presentation, to the second account of the social networking system, of a restricted graphic design icon interface, wherein the restricted graphic design icon interface includes one or more additional content items shared to the social networking system, wherein the one or more additional content items include the restricted graphic design icon.

16. The one or more non-transitory computer-readable media storing instructions of claim 15, wherein identifying the characteristic associated with the first account is based at least in part on one or more of:
user information associated with the first account,
account settings associated with the first account,
interaction data associated with the first account, or
location data of a computing device associated with the first account.

17. The one or more non-transitory computer-readable media storing instructions of claim 15, wherein the selectable control associated with the restrictive graphic design icon is presented via at least one of:
a home screen,
a newsfeed, or
an attribution link associated with a second content item.

18. The one or more non-transitory computer-readable media storing instructions of claim 15, the operations further comprising:
presenting, to the first account via the computing device associated with the first account, one or more controls associated with content creation functionality,
wherein the one or more controls associated with content creation functionality and the restricted graphic design icon are presented prior to a generation of the content item.

19. The one or more non-transitory computer-readable media storing instructions of claim 15, wherein the identifier associated with the restricted graphic design icon includes at least one of:
an attribution link; or
a hashtag.

20. The method of claim 1, wherein the content item is a first content item, and where the content item comprising the restricted graphic design icon further includes one or more selectable controls associated with generating a second content item including the restricted graphic design icon.
